(19) United States
(12) Patent Application Publication
(10) Pub. No.: US 2016/0180414 A1
(43) Pub. Date: Jun. 23, 2016

(54) System and Method of Reviewing Service Providers and Their Customers

(71) Applicant: Online Reviews, LLC, Parker, CO (US)

(72) Inventors: Deborah Willard, Elizabeth, CO (US); Denis Zilberberg, Sunny Isles, FL (US)

(21) Appl. No.: 14/973,138

(22) Filed: Dec. 17, 2015

Related U.S. Application Data
(60) Provisional application No. 62/093,578, filed on Dec. 18, 2014.

(51) Int. Cl. G06Q 30/02

(52) U.S. Cl. CPC G06Q 30/0282

(57) ABSTRACT

The present invention provides a system and method of reviewing service providers. The system and method can verify the identity of a rater and receive the rater's review of a service provider. The review is validated and the reviewed service provider then has an opportunity to respond to a negative review. The service provider's response may be used to adjust the rating of the service provider. The review is then posted.

### CROSS-REFERENCE TO RELATED APPLICATIONS

This application claims priority under 35 U.S.C. §119(e) to U.S. Provisional Patent Application Ser. No. 62/093,578 filed Dec. 18, 2014, which is incorporated herein in its entirety by reference.

### FIELD

The present invention relates generally to a system and method of reviewing service providers. More specifically, the present invention relates to a system and method that can verify the identity of a rater and receive the rater's review of a service provider. The review is validated and the reviewed service provider then has an opportunity to respond to a negative review. The service provider's response may be used to adjust the rating of the service provider. The review is then posted on the internet or another network, including a social media site.

### BACKGROUND

Consumers frequently have a large number of options when making purchases or selecting a professional service provider. To help narrow down the number of options and make an informed choice, many consumers search for and read reviews of products and service providers.

Many web-sites and other media sources cater to the consumer's need for information about products and service providers. Whether using internet based media or traditional media forms, rating products and service providers has become a major industry. Unfortunately, many ratings of service providers that consumers encounter include inaccurate information in the form of reviews that are unreliable or biased.

There are many causes for these inaccurate reviews. Most review systems have no boundaries or rules defining a valid review. The lack of rules and validation of reviews allows almost anything to be submitted and displayed as a review of a service provider. This lack of rules is exasperated by today's interconnected world where, because of the animosity provided by the internet, many people feel empowered to write highly critical reviews of service providers that may not be accurate. Some individuals feel empowered behind their computer to share their experience with the world and can submit almost anything, fair or unfair, in a review because the review site has not defined rules for valid reviews.

Currently, many web-sites and other media sources allow the posting of reviews on any number of service providers in any industry. Most review systems allow for anyone to post anything simply to generate a “new” traffic visitor to exploit advertisements and services available on that site. Most review sites do not concentrate on a specific service industry to help improve the industry but rather target all products and services. Because these review sites have no stake in a particular industry, they can be very damaging to service providers.

Further, few review systems validate the accuracy of data received from raters or allow a reviewed service provider to respond to a review. The systems make no effort, and have no policy or method, of checking the facts of a review or require documentation to substantiate a review that is submitted. Additionally, although some review systems claim that anonymous posts are not allowed, these systems generally allow a rater to create an account without even attempting to verify the identity of the rater.

Unfortunately, most review sites appear to encourage negative reviews and do not encourage or reward positive reviews. Thus, negative reviews generally dominate review sites and the negative reviews are most frequently displayed by web-based search engines. This is especially true for reviews of service providers in the animal and pet industries.

Most review sites will not remove or correct a review even if the reviewed service provider can show the review is inaccurate or false. Most review systems do not allow a service provider to respond to a review. When a review system does allow a reviewed service providers to respond to a review, the service provider's response is rarely given prominence equal to the underlying negative review. Therefore the service provider's response is frequently not seen by the consumer. In some cases, review systems hide or deemphasize responses by service providers by posting them on a separate page or in a smaller font size.

These problems with current review sites allow the submission of biased or invalid reviews that can be used to manipulate the marketplace by deceiving consumers and unfairly punishing businesses and service providers. Some people leverage the ease of writing a negative review, and the difficulty service providers have in responding to the negative review, to threaten or coerce a service provider in an attempt to obtain a service discount. Further, sometimes fake or false reviews are submitted for service providers not actually used. A false or inaccurate internet review of a service provider can be devastating to a business, and more damaging than a negative review in traditional print media because of the world-wide accessibility, searchability, and permanence provided by the internet.

A valid review system has many benefits to the marketplace in general and to consumers and service providers. Valid reviews can improve the quality of a service industry by encouraging good behavior, or punishing bad performance, by influencing consumer decisions when selecting services and service providers. A good professional reputation is essential to successful business. Conscientious service providers work hard to achieve and maintain a good professional reputation. Many service providers work very hard to ensure consumer loyalty and good will. However, even the best intentioned service providers will occasionally fail to provide adequate service or eventually upset one of their customers. A valid negative review can help conscientious service providers identify problems, correct problems, and provide better services to consumers.

An example of a valid review is a review submitted by an actual consumer based on a real interaction with a service provider. Some examples of invalid or biased reviews are reviews submitted by a person who has not used or interacted with the service provider, a falsified review (for example, submitted or encouraged by a competitor), or a review submitted by an unhappy or disgruntled employee, sub-contractor, or vendor.

Many problems with current rating systems can be traced back to the failure to verify the identity of the rater, validate a review, or allow a rated service provider to respond to a review. One way to instill consumer and professional confidence in rating systems is to build integrity and trust into the rating system.

### SUMMARY

There is a need for a system and method of providing reviews of service providers which can verify the validity of a review while allowing the reviewed service provider an opportunity to respond to a negative review.

The present disclosure can provide a number of advantages depending on the particular aspect, embodiment, and/or configuration. One aspect of the present invention is a system and method for a review system that validates reviews to provide better information about service providers to consumers. Another aspect of the present invention is a review system that identifies raters and requires the rater to submit documentation to substantiate a negative review. Yet another aspect of the present invention is a review system that notifies service providers of reviews and gives service providers an opportunity to respond to a review. Another aspect of the present invention is a review system in which the service provider can provide an assessment of the service provided to the rater and enter a review of the rater. Still another aspect of the review system is a dispute resolution system that gives raters and service providers a chance to resolve problems, correct deficiencies in service provided, and revise ratings of a service. The above and other advantages will be apparent from the disclosure.

One aspect of the present invention is a rating system. The rating system includes, but is not limited to: (1) a communication interface configured to receive a communication comprising a review of a service provider from a rater; and (2) a processor. The processor is configured to: receive the review from the communication interface; identify the rater; determine if additional information is required from the rater; evaluate the review received from the rater; identify the service provider associated with the review; notify the service provider and the rater when the review system validates the rater's review; determine if the service provider is registered with the system; determine if the service provider is eligible to provide a review of the rater's review; receive the service provider's review; receive responses to additional questions from the service provider; determine if a dispute resolution process is requested by one of the rater and the service provider; and post the review.

In one embodiment, the rating system further comprises: a web server; a user database; a rating database that stores review of raters and service providers; and a rating engine to identify negative review and request validation of the review from the rater.

Another aspect of the present invention is a method of providing a review system. The method generally includes, but is not limited to: (1) receiving an identified rater's review of a service provider; (2) determining if additional information is required from the rater; (3) evaluating the rater's review; (4) notifying the service provider and the rater when the review system validates the rater's review; (5) determining if the service provider is registered with the review system; (6) determining if the service provider is eligible to provide a review of the rater's review; (7) receiving the service provider's review; (8) receiving responses to additional questions from the service provider; (9) determining if a dispute resolution process is requested by one of the rater and the service provider; and (10) posting the review.

In accordance with another aspect of the present invention, a non-transitory computer-readable medium containing computer executable instructions is provided that, when executed by a processor, cause the processor to execute a method of a review system. The computer-readable instructions generally comprise, but are not limited to: (1) instructions to receive a rater's review of a service provider; (2) instructions to determine if additional information is required from the rater; (3) instructions to review the rater's review; (4) instructions to notify the service provider and the rater when the review system validates the rater's review; (5) instructions to determine if the service provider is registered with the review system; (6) instructions to determine if the service provider is eligible to provide a review of the rater's review; (7) instructions to receive the service provider's review; (8) instructions to receive response to additional questions from the service provider; (9) instructions to determine if a dispute resolution process is requested by one of the rater and the service provider; and (10) instructions to post the review.

These and other needs are addressed by the various aspects, embodiments, and/or configurations of the present disclosure. Also, while the disclosure is presented in terms of exemplary and optional embodiments, it should be appreciated that individual aspects of the disclosure can be separately claimed.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refer to any process or operation done without material human input when the process or operation is performed. However, a process or operation can be automatic, even though performance of the process or operation uses material or immaterial human input, if the input is received before the performance of the process or operation. Human input is deemed to be material if such input influences how the process or operation will be performed. Human input that consents to the performance of the process or operation is not deemed to be “material.”

The term “bus” and variations thereof, as used herein, can refer to a subsystem that transfers information and/or data between various components. A bus generally refers to the collection communication hardware interface, interconnects, bus architecture, standard, and/or protocol defining the communication scheme for a communication system and/or communication network. A bus may also refer to a part of a communication hardware that interfaces the communication hardware with the interconnects that connect to other components of the corresponding communication network. The bus may be for a wired network, such as a physical bus, or wireless network, such as part of an antenna or hardware that couples the communication hardware with the antenna. A bus architecture supports a defined format in which information and/or data is arranged when sent and received through a communication network. A protocol may define the format and rules of communication of a bus architecture.

A “communication modality” can refer to any protocol- or standard defined or specific communication session or interaction, such as Voice-Over-Internet-Protocol (“VoIP), cellular communications (e.g., IS-95, 1G, 2G, 3G, 3.5G, 4G, 4G/IMT-Advanced standards, 3GPP, WIMAX™, GSM, CDMA, CDMA2000, EDGE, 1xEVDO, iDEN, GPRS, HSPDA, TDMA, UMA, UMTS, ITU-R, and 5G), Bluetooth™, text or instant messaging (e.g., AIM, Blauk, eBuddy, Gadu-Gadu, IBM Lotus Sametime, ICQ, iMessage, IMVU, Lync, MXit, Paltalk, Skype, Tencent QQ, Windows Live Messenger™ or MSN Messenger™, Wireclub, Xfire, and Yahoo! Messenger™), email, Twitter (e.g., tweeting), Digital Service Protocol (DSP), and the like.

The term “communication system” or “communication network” and variations thereof, as used herein, can refer to a collection of communication components capable of one or more of transmission, relay, interconnect, control, or otherwise manipulate information or data from at least one transmitter to at least one receiver. As such, the communication may include a range of systems supporting point-to-point or broadcasting of the information or data. A communication system may refer to the collection individual communication hardware as well as the interconnects associated with and connecting the individual communication hardware. Communication hardware may refer to dedicated communication hardware or may refer a processor coupled with a communication means (i.e., an antenna) and running software capable of using the communication means to send and/or receive a signal within the communication system. Interconnect refers some type of wired or wireless communication link that connects various components, such as communication hardware, within a communication system. A communication network may refer to a specific setup of a communication system with the collection of individual communication hardware and interconnects having some definable network topography. A communication network may include wired and/or wireless network having a pre-set to an ad hoc network structure.

The term “computer-readable medium,” as used herein refers to any tangible storage and/or transmission medium that participates in providing instructions to a processor for execution. Such a medium may take many forms, including but not limited to, non-volatile media, volatile media, and transmission media. Non-volatile media includes, for example, non-volatile random access memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a compact disc read only memory (CD-ROM), any other optical medium, punch cards, paper tape, any other physical medium with patterns of holes, a random access memory (RAM), a programmable read only memory (PROM), and erasable programmable read only memory EPROM, a FLASH-EPROM, a solid state medium like a memory card, any other memory chip or cartridge, a carrier wave as described hereinafter, or any other medium from which a computer can read. A digital file attachment to an e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. It should be noted that any computer readable medium that is not a signal transmission may be considered non-transitory.

The term “module” as used herein refers to any known or later developed hardware, software, firmware, artificial intelligence, fuzzy logic, or combination of hardware and software that is capable of performing the functionality associated with that element.

The term “desktop” refers to a metaphor used to portray systems. A desktop is generally considered a “surface” that may include pictures, called icons, widgets, folders, etc. that can activate and/or show applications, windows, cabinets, files, folders, documents, and other graphical items. The icons are generally selectable to initiate a task through user interface interaction to allow a user to execute applications and/or conduct other operations.

The term “display” refers to a portion of a physical screen used to display the output of a computer to a user.

The term “displayed image” refers to an image produced on the display. A typical displayed image is a window or desktop. The displayed image may occupy all or a portion of the display.

The term “electronic address” can refer to any contactable address, including a telephone number, instant message handle, e-mail address, Uniform Resource Locator (“URL”), Global Universal Identifier (“GUID”), Universal Resource Identifier (“URI”), Address of Record (“AOR”), electronic alias in a database, etc., combinations thereof

The terms “determine,” “calculate,” and “compute,” and variations thereof, as used herein, are used interchangeably and include any type of methodology, process, mathematical operation, or technique.

It shall be understood that the term “means,” as used herein, shall be given its broadest possible interpretation in accordance with 35 U.S.C., Section 112, Paragraph 6 or other applicable law. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The term “profile,” as used herein, can refer to any data structure, data store, and/or database that includes one or more items of information associated with a rater or a service provider.

The term “in communication with,” as used herein, refers to any coupling, connection, or interaction using electrical signals to exchange information or data, using any system, hardware, software, protocol, or format, regardless of whether the exchange occurs wirelessly or over a wired connection.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

The accompanying drawings, which are incorporated herein and constitute a part of the specification, illustrate embodiments of the invention and together with the Summary given above and the Detailed Description of the drawings given below serve to explain the principles of these embodiments. In certain instances, details that are not necessary for an understanding of the disclosure or that render other details difficult to perceive may have been omitted. It should be understood, of course, that the invention is not necessarily limited to the particular embodiments illustrated herein. Additionally, it should be understood that the drawings are not necessarily to scale.

FIG. 1 is an example communications/data processing network system that may be used in conjunction with embodiments of the present disclosure;

FIG. 2 is an example computer system that may be used in conjunction with embodiments of the present disclosure;

FIG. 3 is a block diagram of a review system of the present disclosure;

FIG. 4A is a view of an embodiment of a user interface for a review system of the present disclosure;

FIG. 4B is a view of an embodiment of a user interface for a review system of the present disclosure;

FIG. 4C is a view of an embodiment of a user interface for a review system of the present disclosure;

FIG. 4D is a view of an embodiment of a user interface for a review system of the present disclosure;

FIG. 4E is a view of an embodiment of a user interface for a review system of the present disclosure;

FIG. 4F is a view of an embodiment of a user interface for a review system of the present disclosure;

FIG. 4G is a view of an embodiment of a user interface for a review system of the present disclosure;

FIG. 4H is a view of an embodiment of a user interface for a review system of the present disclosure;

FIG. 4I is a view of an embodiment of a user interface for a review system of the present disclosure;

FIG. 4J is a view of an embodiment of a user interface for a review system of the present disclosure;

FIG. 4K is a view of an embodiment of a user interface for a review system of the present disclosure;

FIG. 4L is a view of an embodiment of a user interface for a review system of the present disclosure;

FIG. 4M is a view of an embodiment of a user interface for a review system of the present disclosure;

FIG. 4N is a view of an embodiment of a user interface for a review system of the present disclosure;

FIG. 4O is a view of an embodiment of a user interface for a review system of the present disclosure;

FIG. 4P is a view of an embodiment of a user interface for a review system of the present disclosure;

FIG. 4Q is a view of an embodiment of a user interface for a review system of the present disclosure;

FIG. 4R is a view of an embodiment of a user interface for a review system of the present disclosure;

FIG. 4S is a view of an embodiment of a user interface for a review system of the present disclosure;

FIG. 4T is a view of an embodiment of a user interface for a review system of the present disclosure;

FIG. 4U is a view of an embodiment of a user interface for a review system of the present disclosure;

FIG. 4V is a view of an embodiment of a user interface for a review system of the present disclosure;

FIG. 4W is a view of an embodiment of a user interface for a review system of the present disclosure;

FIG. 4X is a view of an embodiment of a user interface for a review system of the present disclosure;

FIG. 4Y is a view of an embodiment of a user interface for a review system of the present disclosure;

FIG. 4Z is a view of an embodiment of a user interface for a review system of the present disclosure;

FIG. 4AA is a view of an embodiment of a user interface for a review system of the present disclosure;

FIG. 4AB is a view of an embodiment of a user interface for a review system of the present disclosure;

FIG. 4AC is a view of an embodiment of a user interface for a review system of the present disclosure;

FIG. 5 is a block diagram of an embodiment of the analysis engine illustrated in the review system of FIG. 3;

FIG. 6 is a flow or process diagram of a method of receiving a review from a rater; and

FIG. 7 is a flow or process diagram of a method of receiving a review from a service provider.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference letter or label.

### DETAILED DESCRIPTION

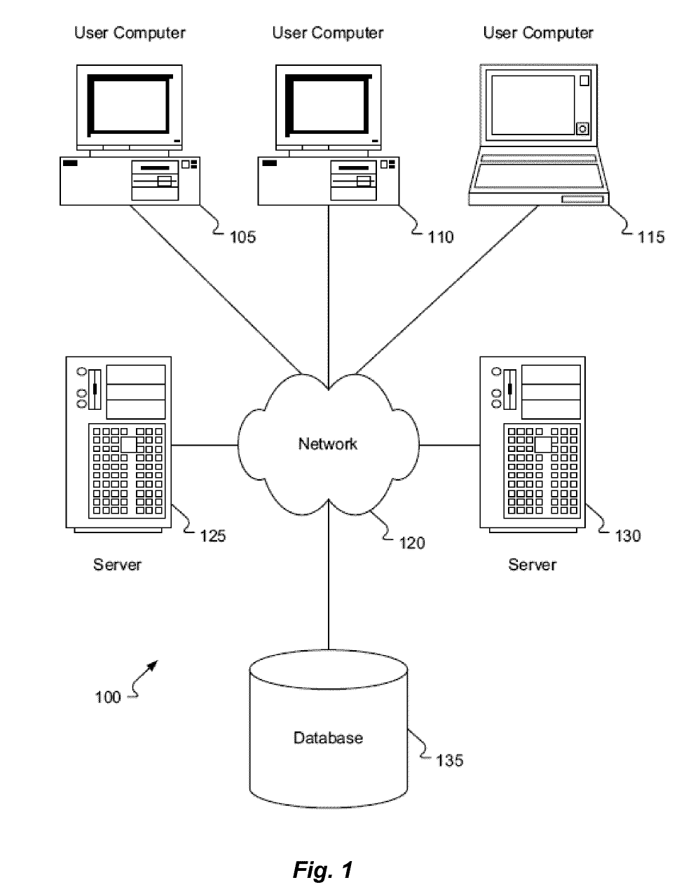

The following detailed description describes one or more embodiments of the disclosed system and method. Referring to FIG. 1, an example network system is provided that may be used in connection with the review system and method disclosed herein. More specifically, FIG. 1 illustrates a block diagram of a system 100 that may be used by a review system to rate service providers and their customers. The system 100 includes one or more user computers 105, 110, and 115. The user computers 105, 110, and 115 may be general purpose personal computers (including, merely by way of example, personal computers and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These user computers 105, 110, 115 may also have any of a variety of applications, including for example, database client and/or server applications, and web browser applications. Alternatively, the user computers 105, 110, and 115 may be any other electronic device, such as a thin-client computer, internet-enabled mobile telephone, and/or personal digital assistant, capable of communicating via a network (e.g., the network 120 described below) and/or displaying and navigating web pages or other types of electronic documents. Although the exemplary system 100 is shown with three user computers, any number of user computers may be supported.

System 100 further includes a network 120. The network 120 may be any type of network familiar to those skilled in the art that can support data communications using any of a variety of commercially-available protocols, including without limitation TCP/IP, SNA, IPX, AppleTalk, and the like. Merely by way of example, the network 120 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth™ protocol known in the art, and/or any other wireless protocol); and/or any combination of these and/or other networks.

The system may also include one or more server computers 125, 130. One server may be a web server 125, which may be used to process requests for web pages or other electronic documents from user computers 105, 110, and 120. The web server can be running an operating system including any of those discussed above, as well as any commercially-available server operating systems. The web server 125 can also run a variety of server applications, including HTTP servers, FTP servers, CGI servers, database servers, Java servers, and the like. In some instances, the web server 125 may publish operations available as one or more web services.

The system 100 may also include one or more file and/or application servers 130, which can, in addition to an operating system, include one or more applications accessible by a client running on one or more of the user computers 105, 110, 115. The server(s) 130 may be one or more general purpose computers capable of executing programs or scripts in response to the user computers 105, 110 and 115. As one example, the server may execute one or more web applications. The web application may be implemented as one or more scripts or programs written in any programming language, such as Java™, C, C#™ or C++, and/or any scripting language, such as Perl, Python, or TCL, as well as combinations of any programming/scripting languages. The application server(s) 130 may also include database servers, including without limitation those commercially available from Oracle, Microsoft, Sybase™, IBM™ and the like, which can process requests from database clients running on a user computer 105.

In some embodiments, an application server 130 may create web pages dynamically for displaying information and reports generated by the performance analysis system. The web pages created by the web application server 130 may be forwarded to a user computer 105 via a web server 125. Similarly, the web server 125 may be able to receive web page requests, web services invocations, and/or input data from a user computer 105 and can forward the web page requests and/or input data to the web application server 130.

In further embodiments, the server 130 may function as a file server. Although for ease of description, FIG. 1 illustrates a separate web server 125 and file/application server 130, those skilled in the art will recognize that the functions described with respect to servers 125, 130 may be performed by a single server and/or a plurality of specialized servers, depending on implementation-specific needs and parameters.

The system 100 may also include a database 135. The database 135 may reside in a variety of locations. By way of example, database 135 may reside on a storage medium local to (and/or resident in) one or more of the computers 105, 110, 115, 125, 130. Alternatively, it may be remote from any or all of the computers 105, 110, 115, 125, 130, and in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10i™, that is adapted to store, update, and retrieve data in response to SQL-formatted commands.

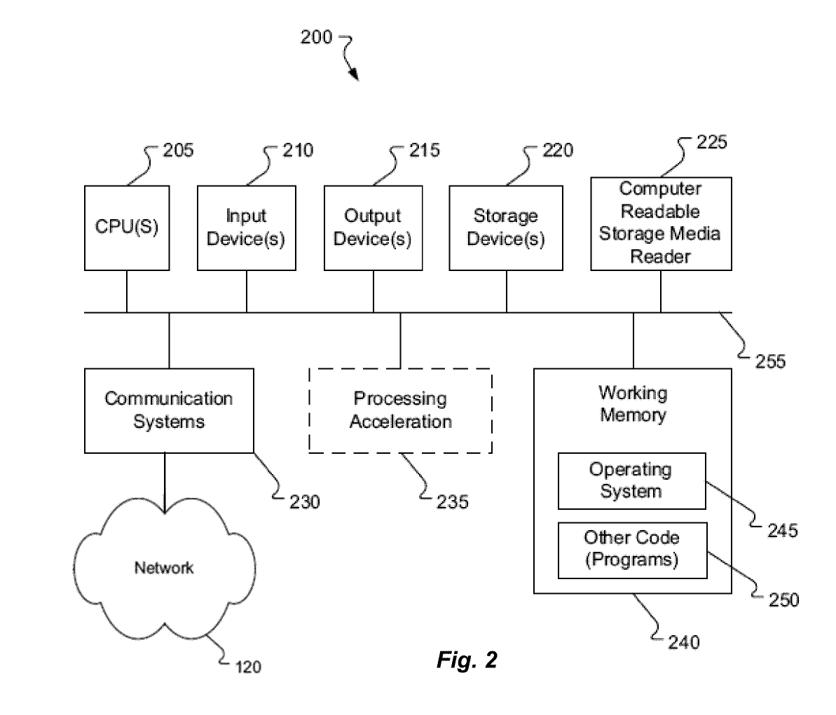

Referring to FIG. 2, an example computer system 200 is provided that may be used in connection with the review system and method disclosed herein. More specifically, FIG. 2 illustrates one embodiment of a computer system 200 upon which the review system or components of a review system of the present invention may be deployed or executed. The computer system 200 is shown comprising hardware elements that may be electrically coupled via a bus 255. The hardware elements may include one or more central processing units (CPUs) 205; one or more input devices 210 (e.g., a mouse, a keyboard, etc.); and one or more output devices 215 (e.g., a display device, a printer, etc.). The computer system 200 may also include one or more storage devices 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225; a communications system 230 (e.g., a modem, a network card (wireless or wired), an infra-red communication device, etc.); and working memory 240, which may include RAM and ROM devices as described above. In some embodiments, the computer system 200 may also include a processing acceleration unit 235, which can include a DSP, a special-purpose processor and/or the like.

The computer-readable storage media reader 225 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 120 and/or any other computer described above with respect to the system 100.

The computer system 200 may also comprise software elements or modules 250, shown as being currently located within the working memory 240, including an operating system 245 and/or other code 250, such as program code implementing a review system or components of a review system of the present invention. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

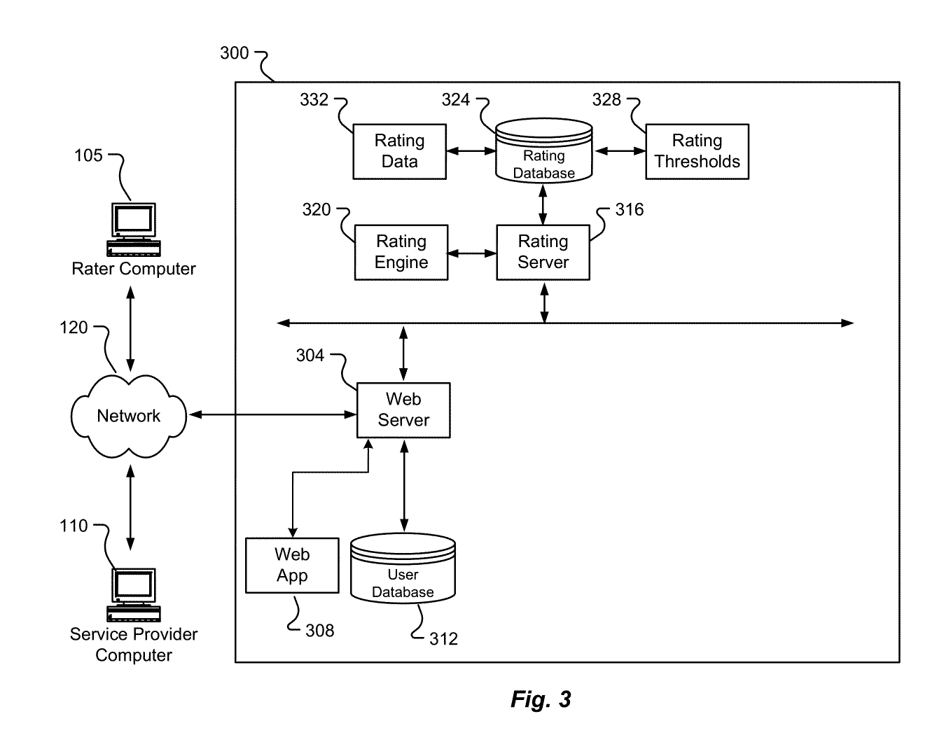

Referring now to FIG. 3, a block diagram of review system 300 of the present invention is illustrated. As shown in FIG. 3, the review system 300 includes multiple servers and databases. The number and configuration of the servers and databases are shown for illustration purposes only, and may be altered without departing from the scope of the present disclosure. For example, a single server and database may be utilized in an embodiment of a review system 300 of the present invention.

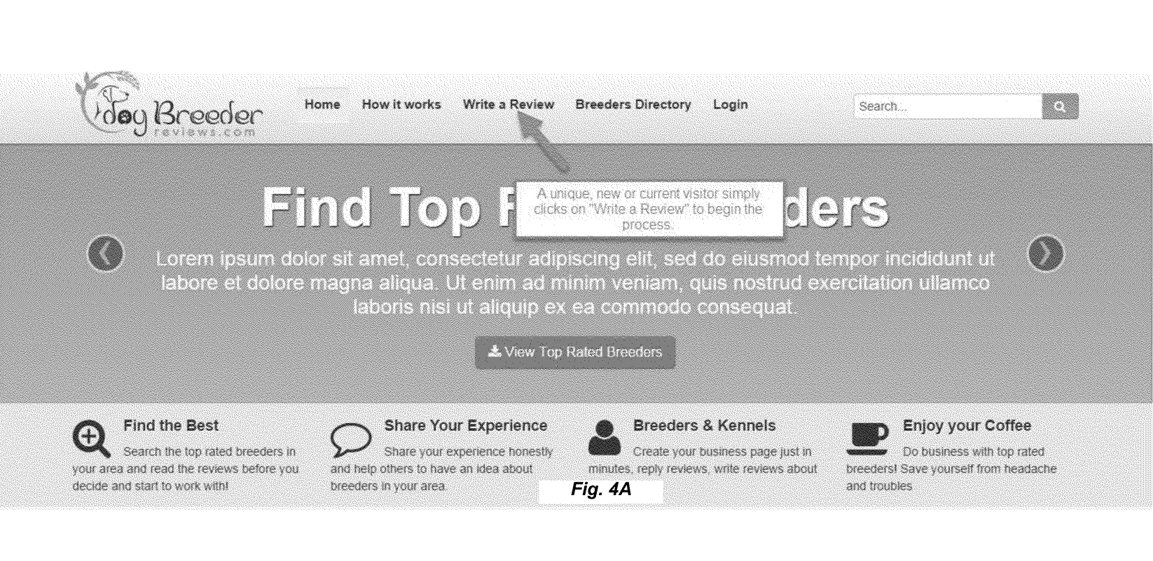

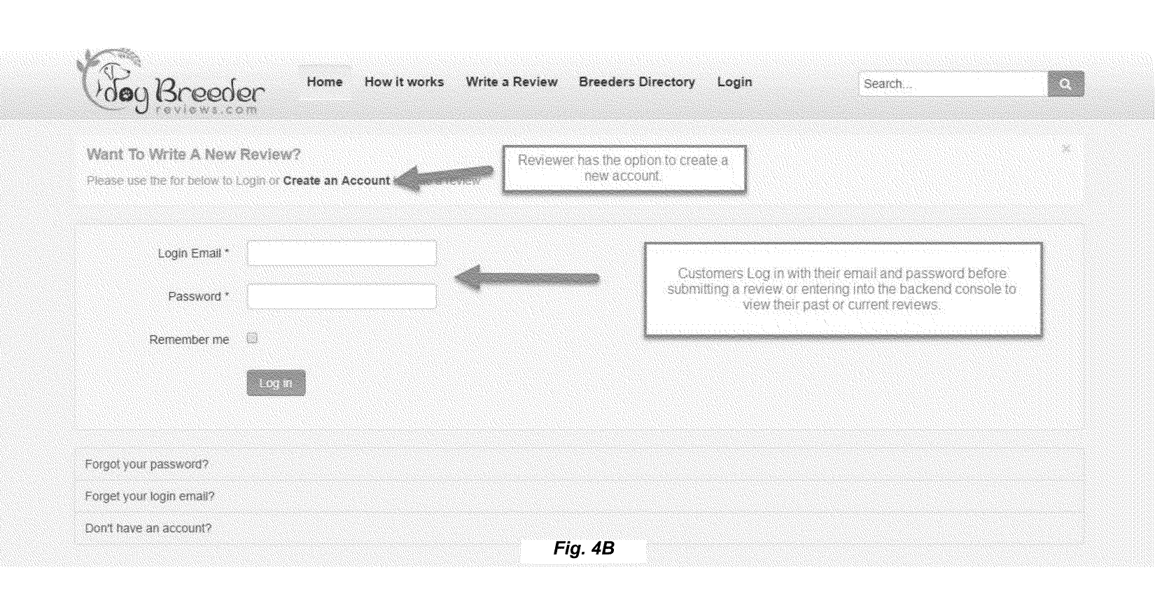

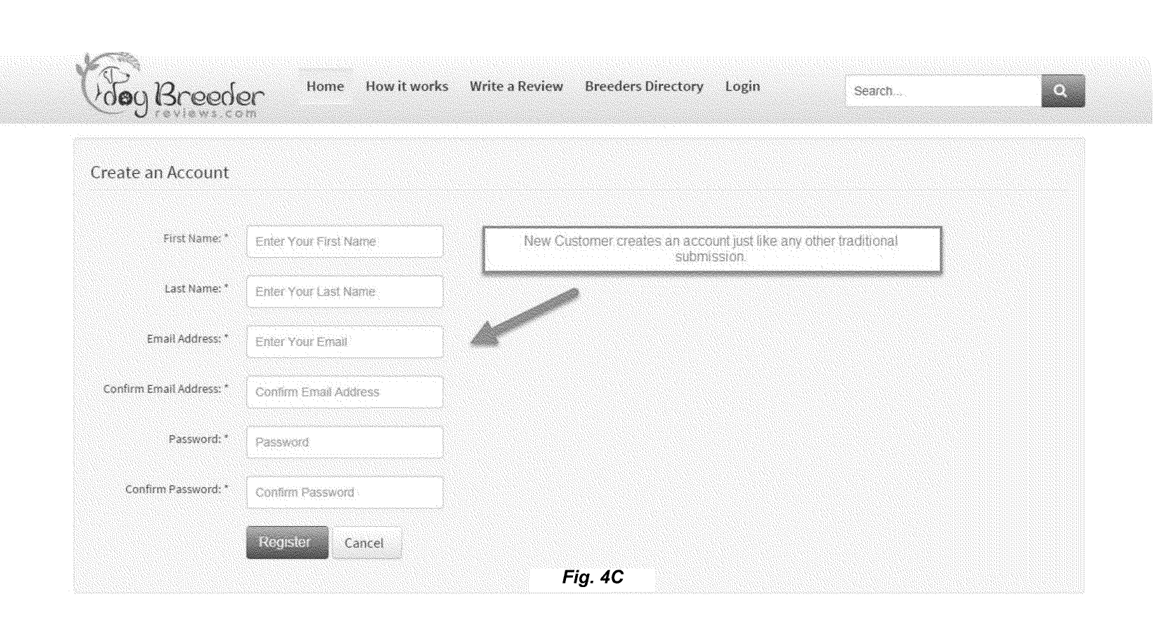

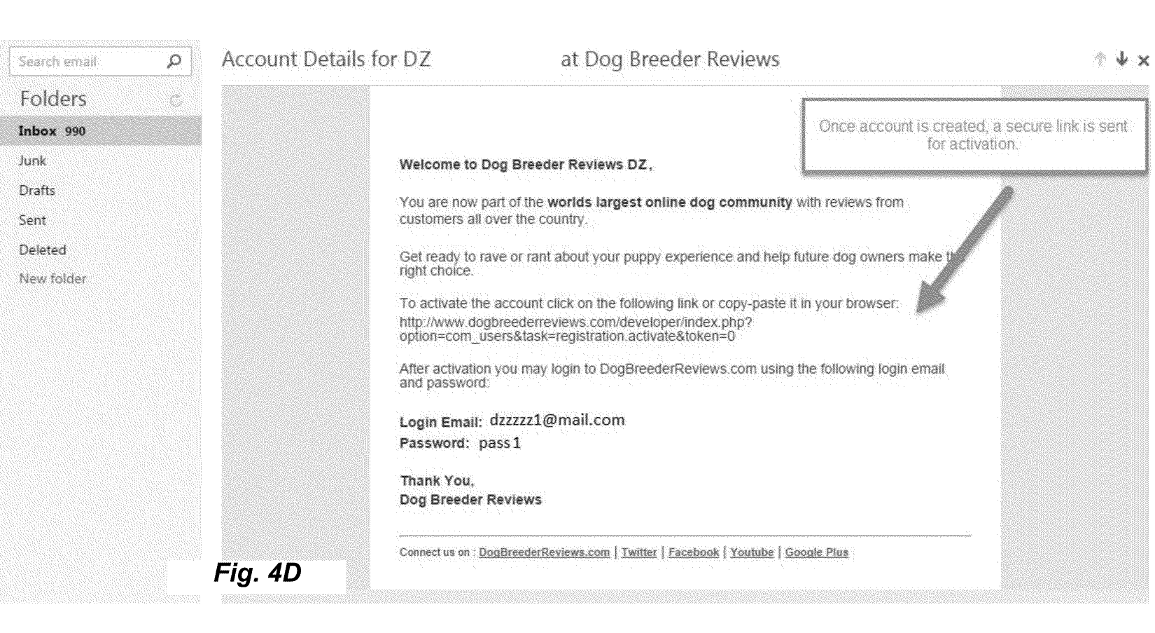

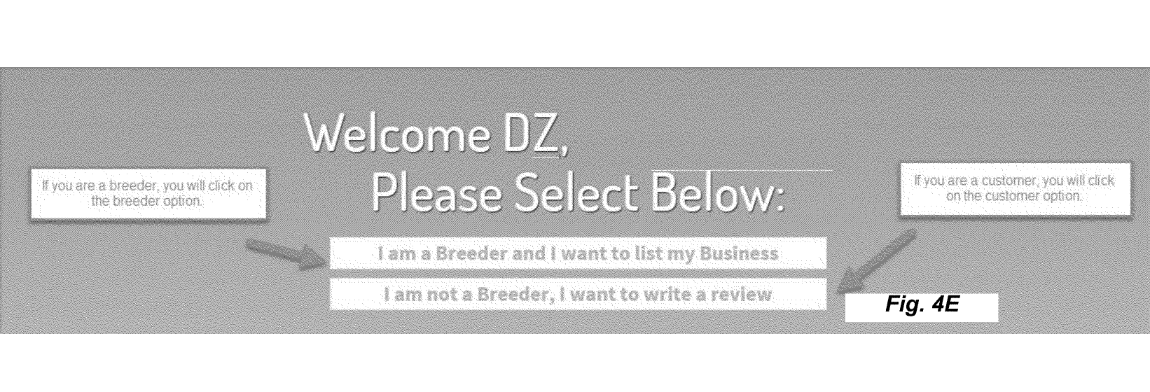

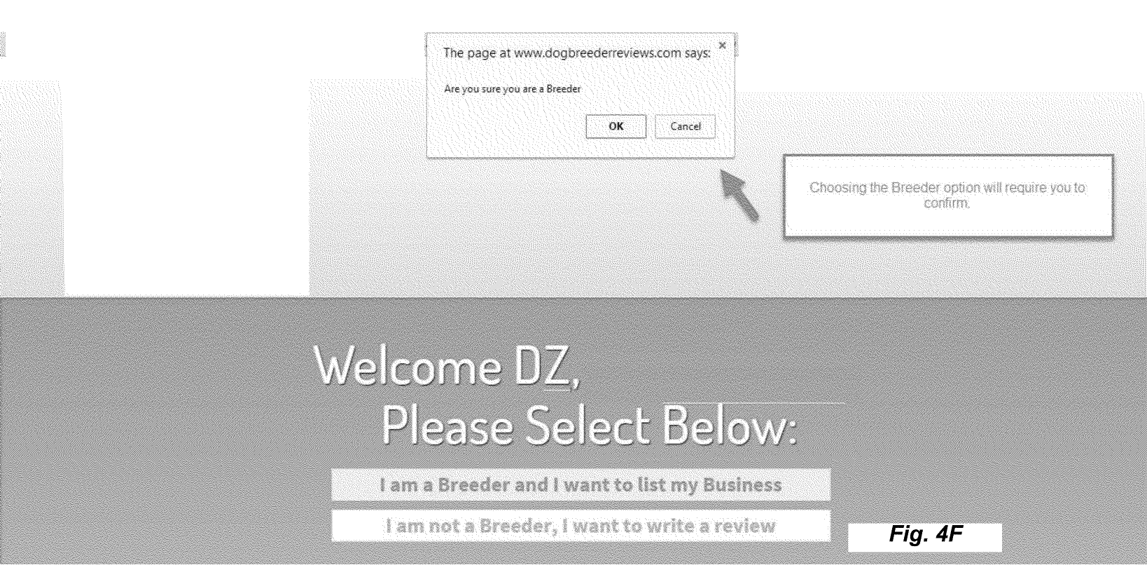

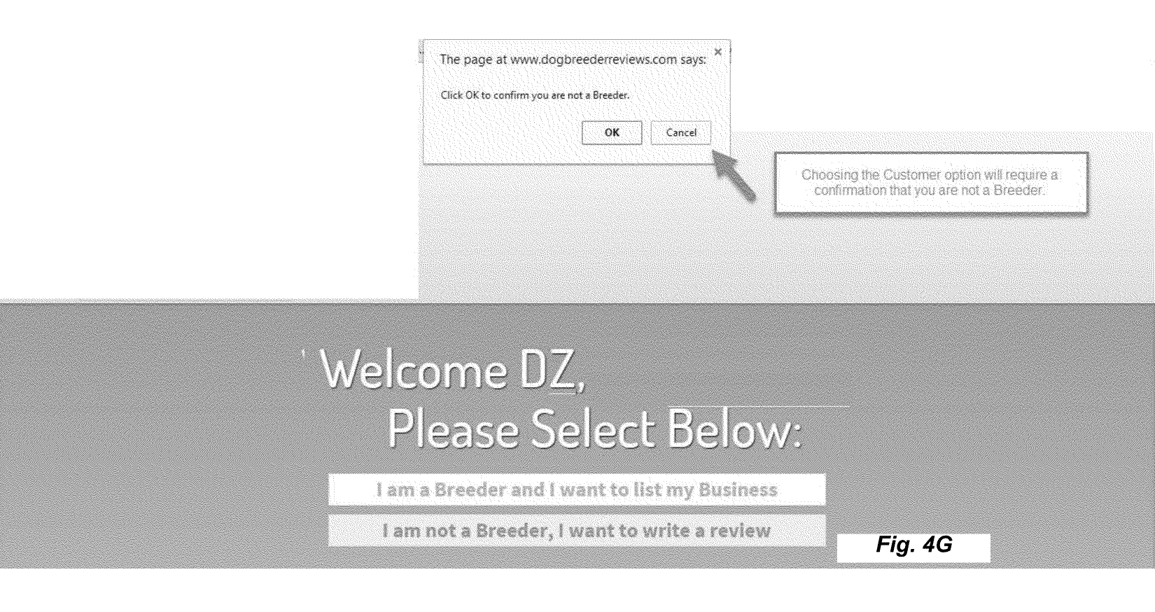

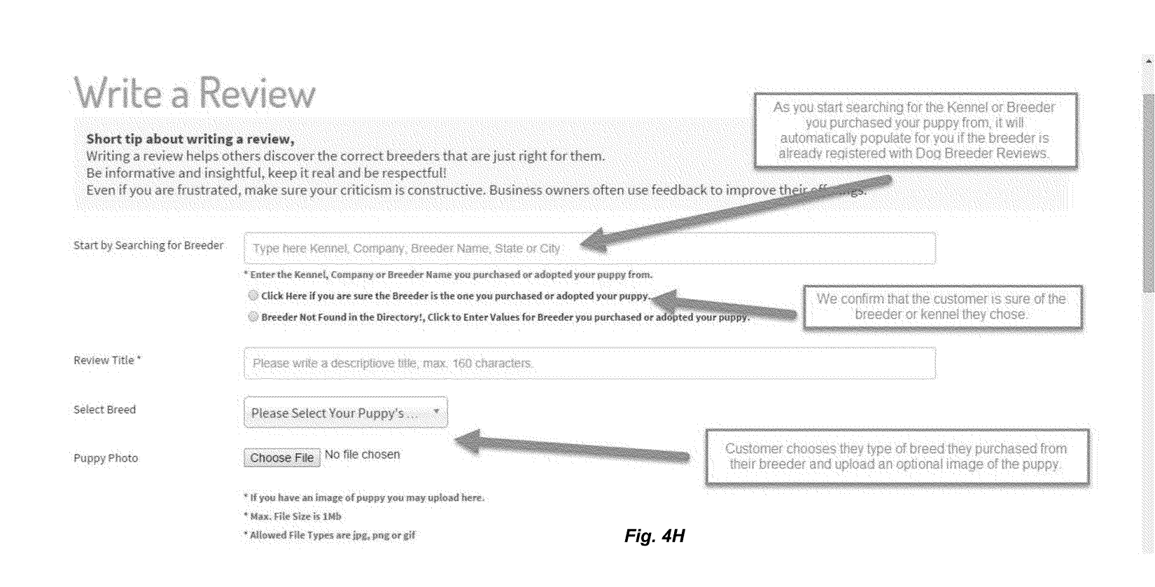

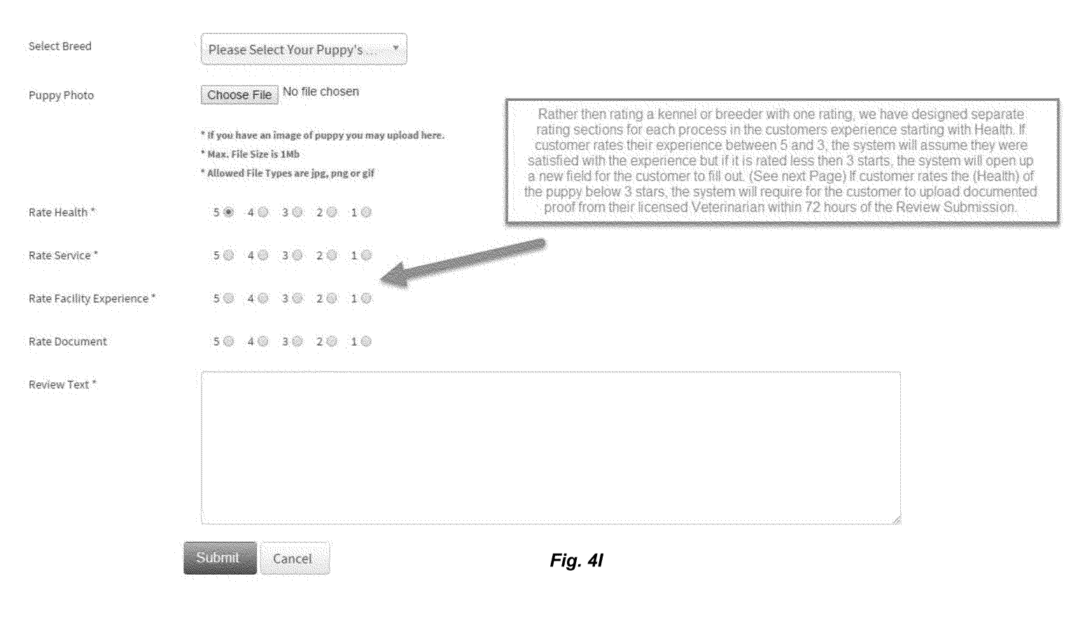

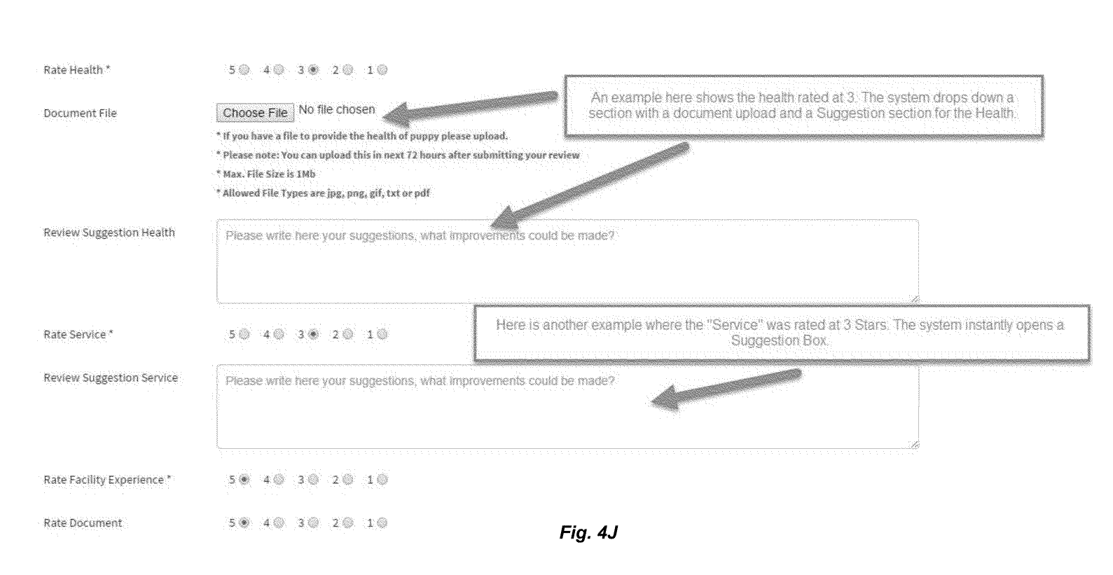

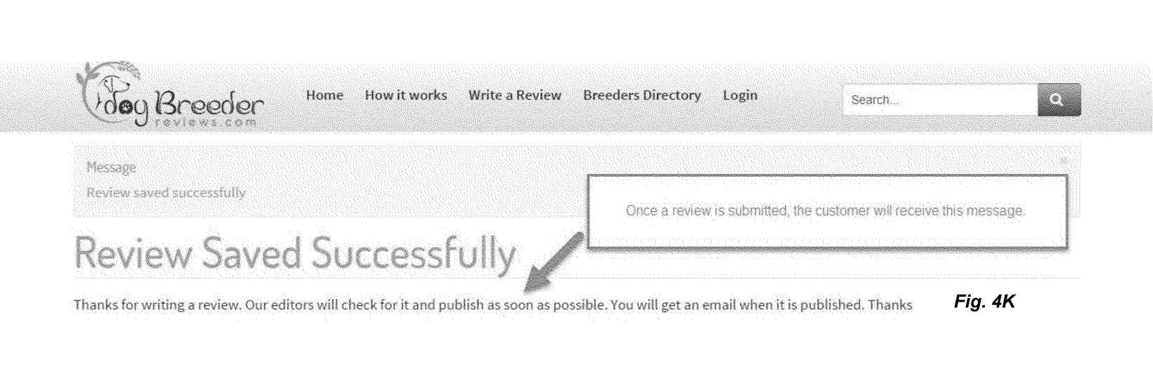

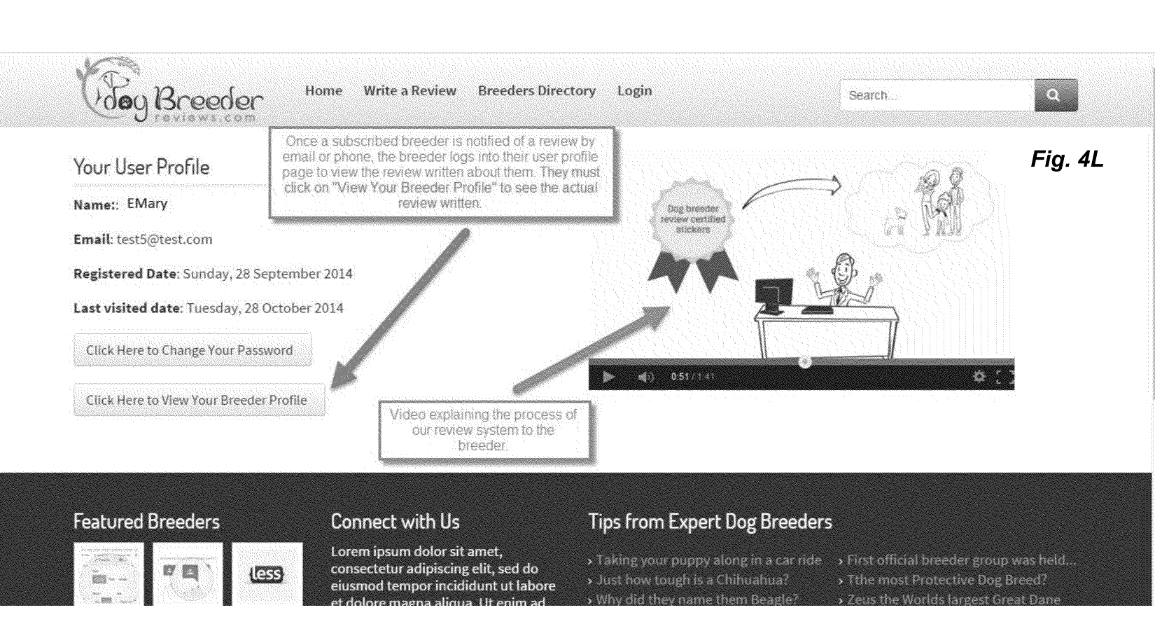

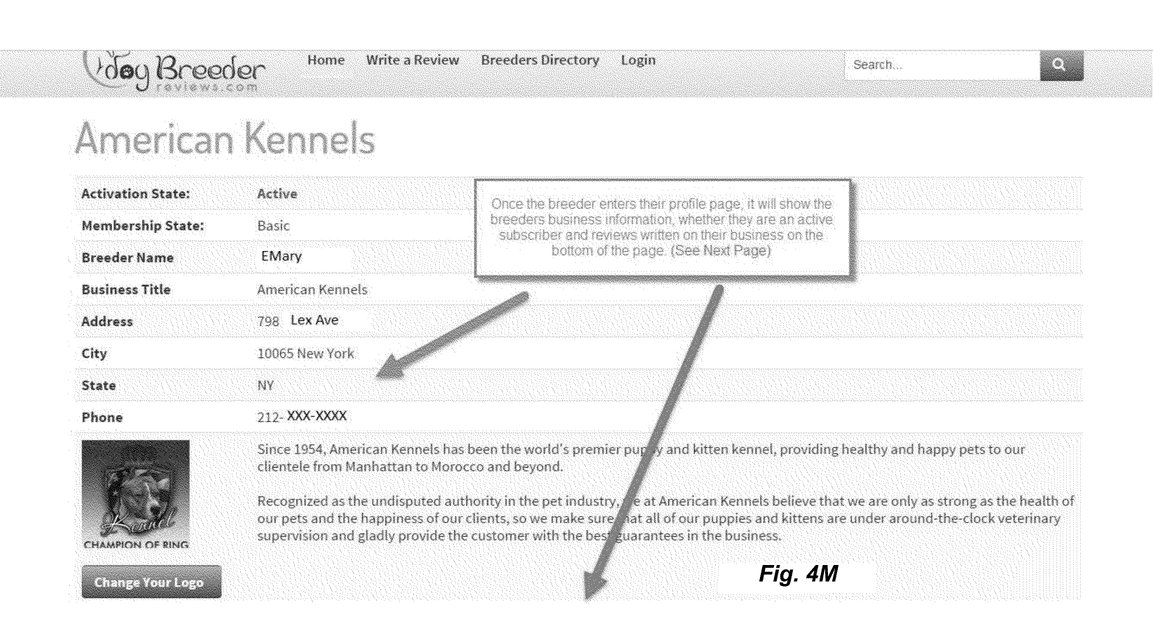

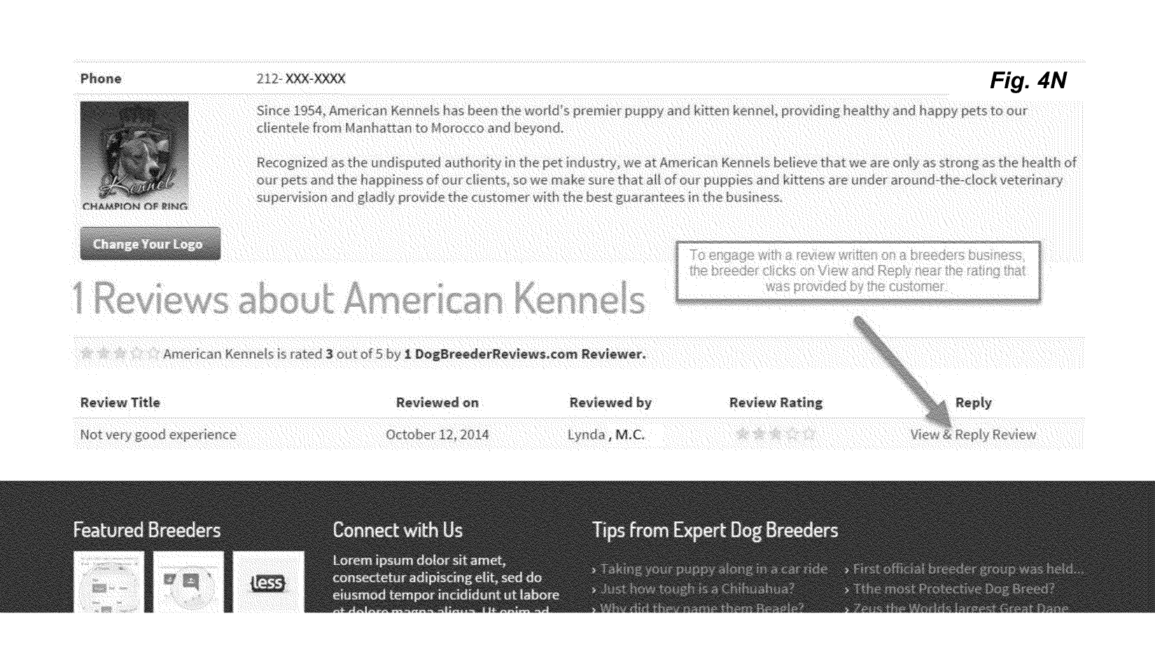

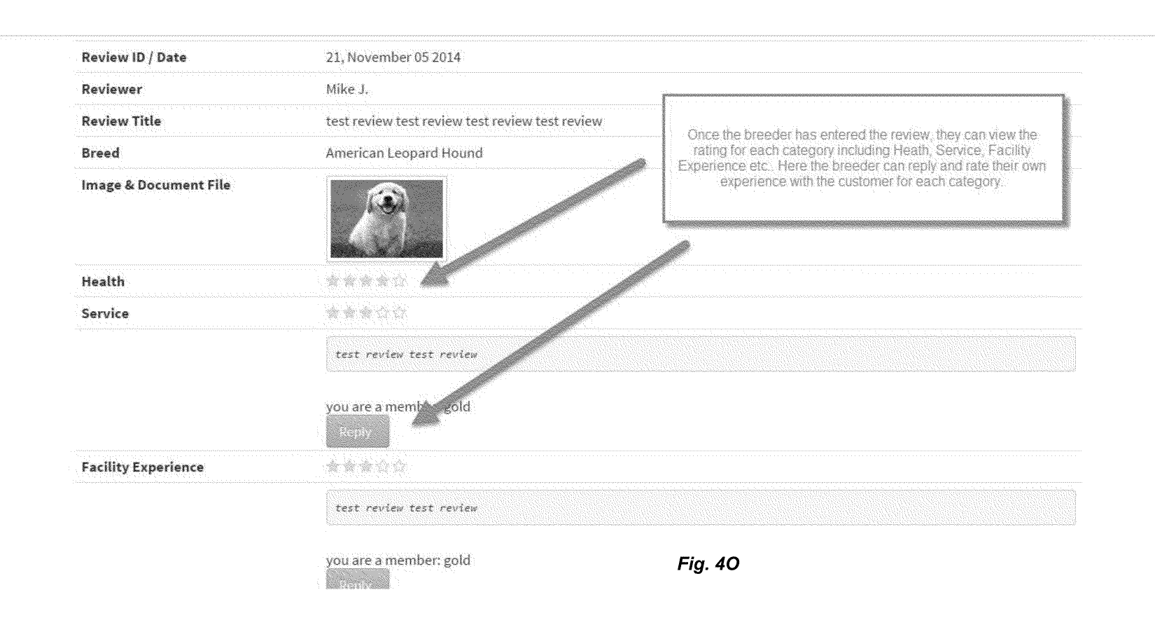

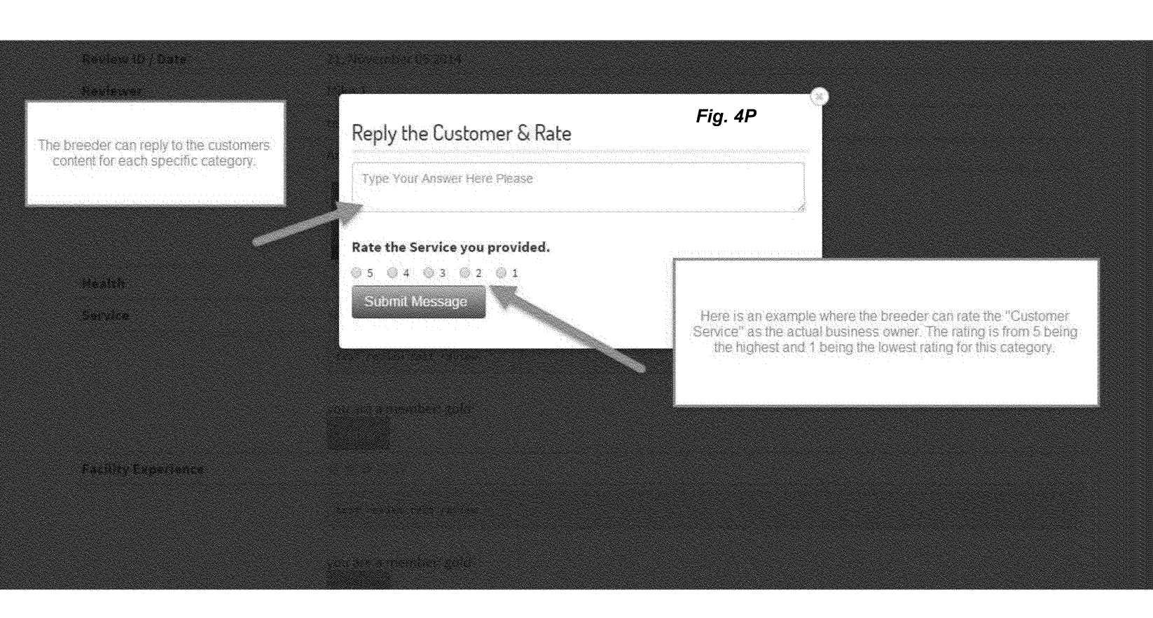

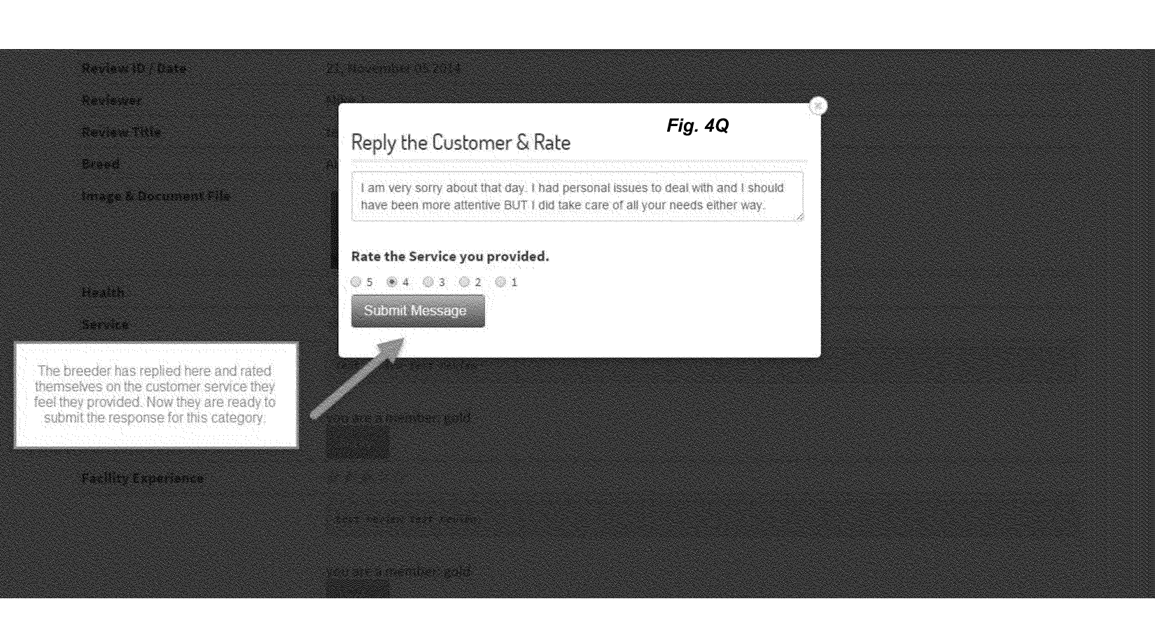

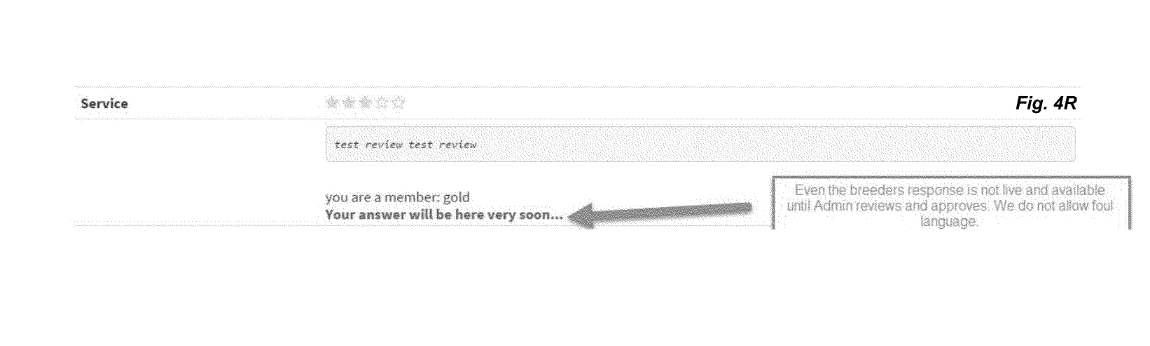

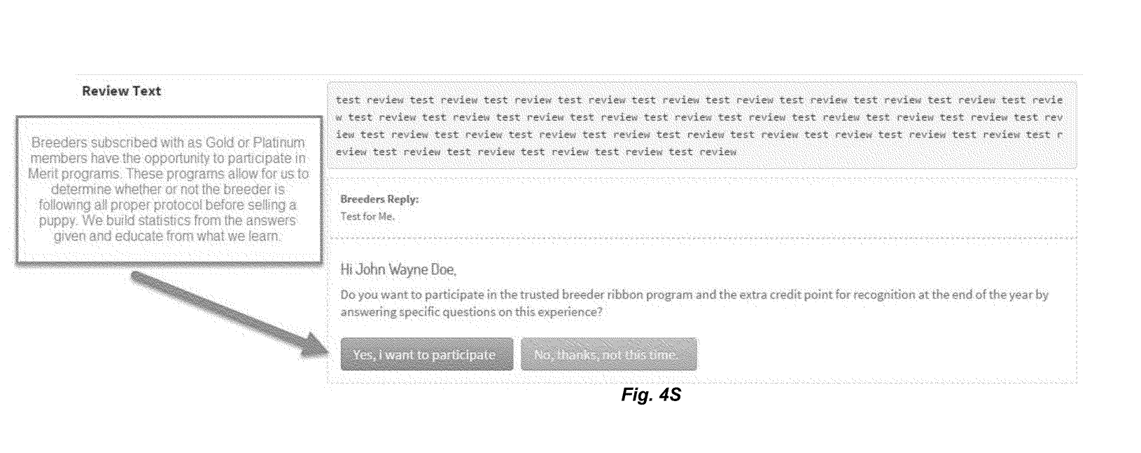

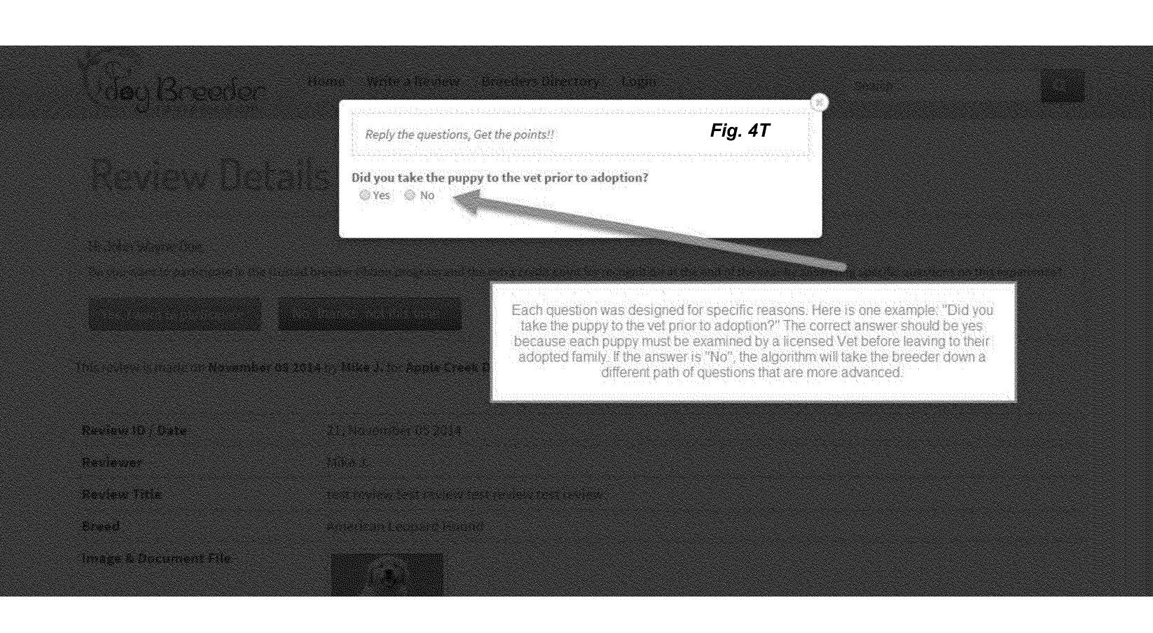

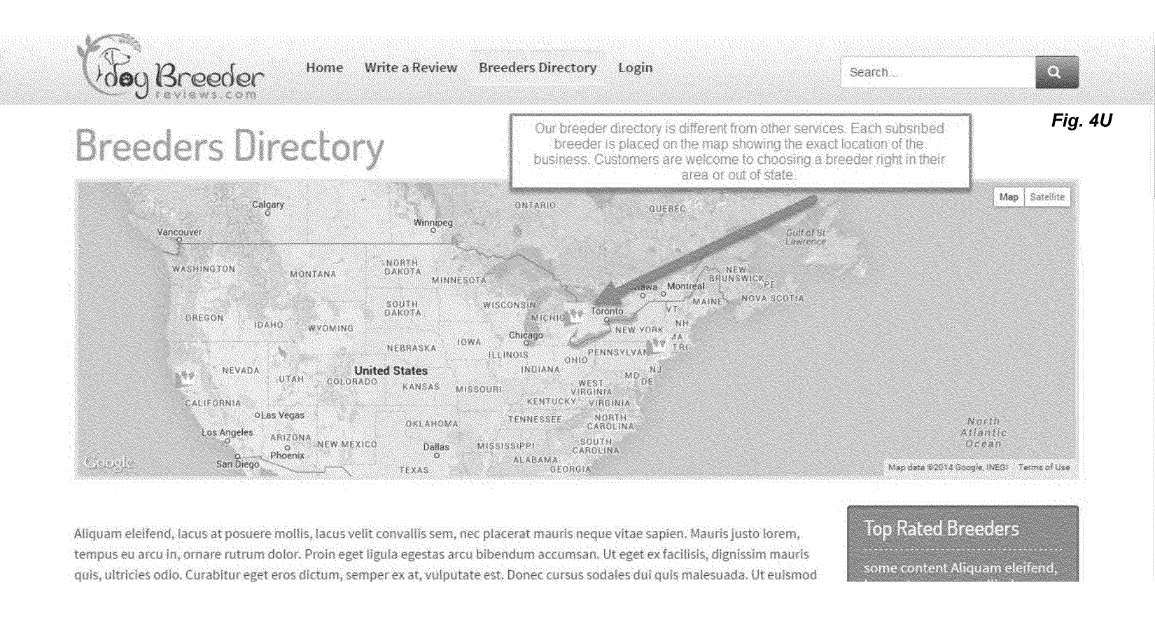

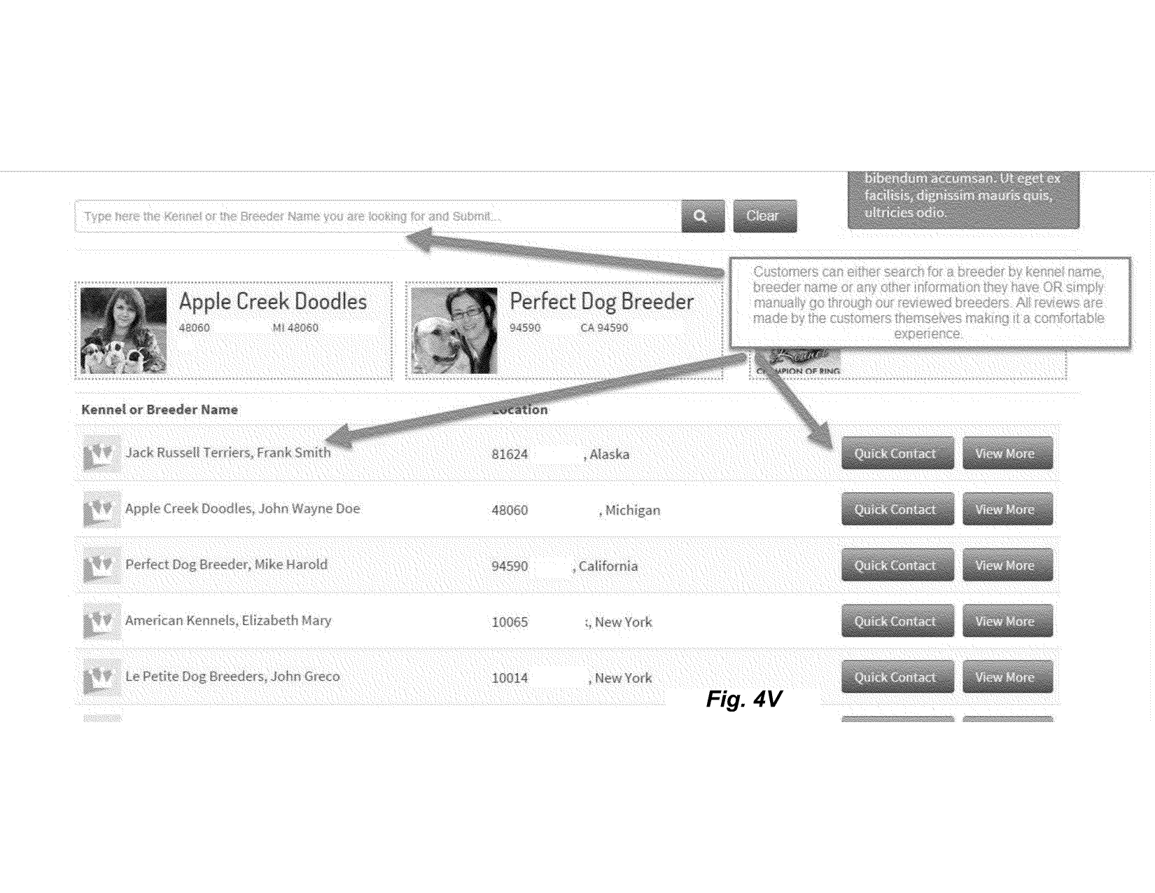

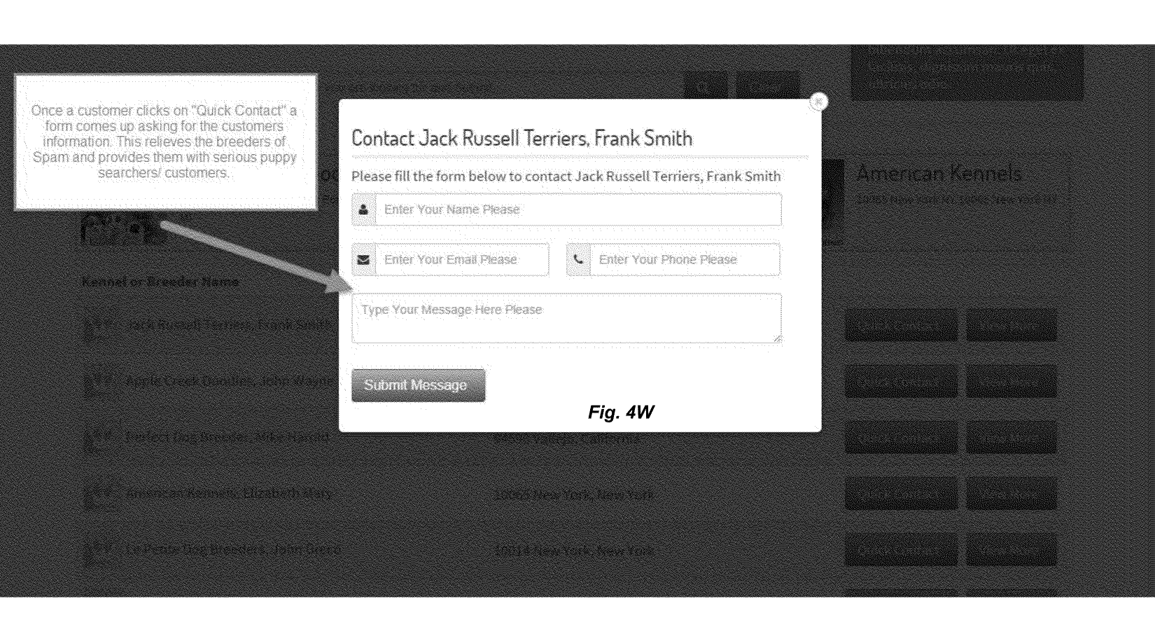

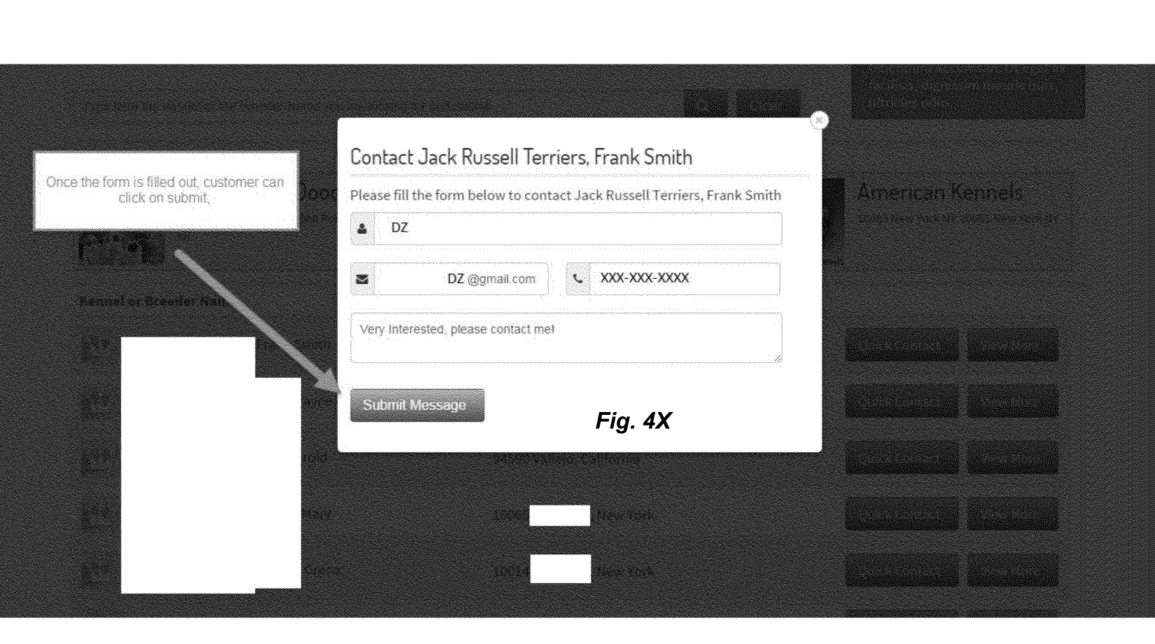

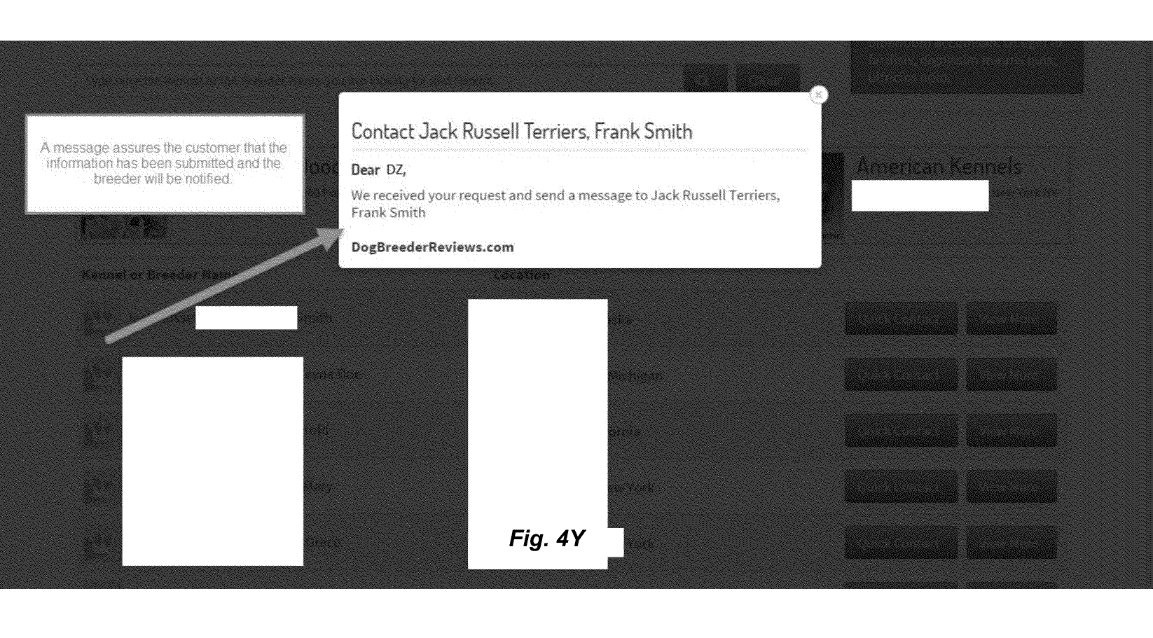

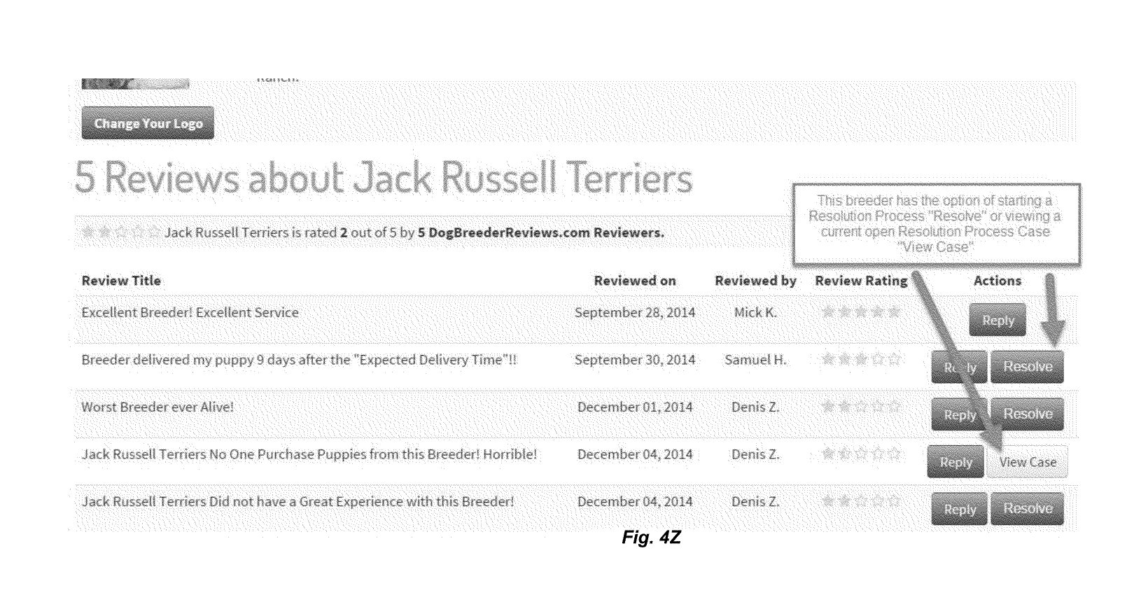

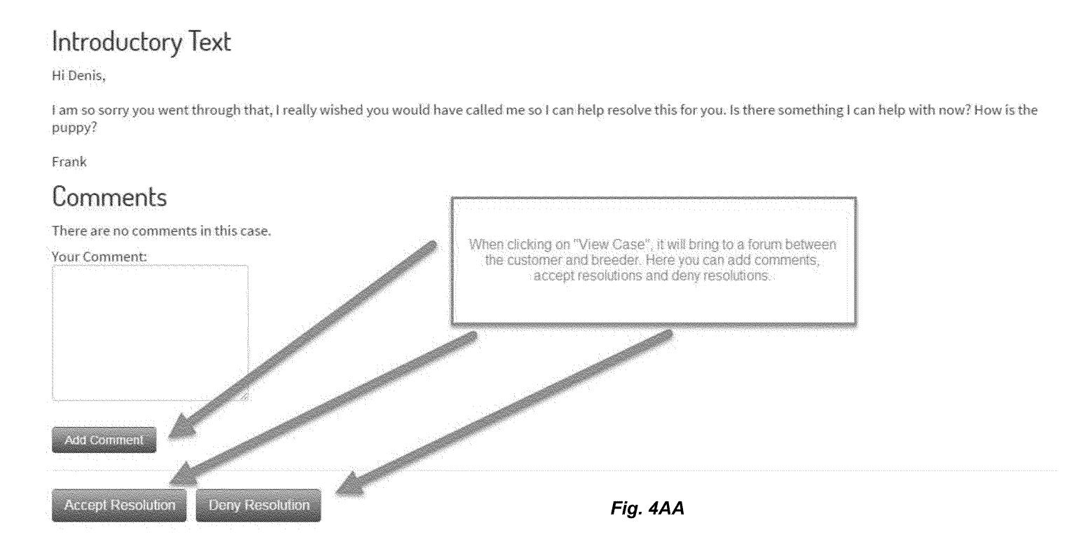

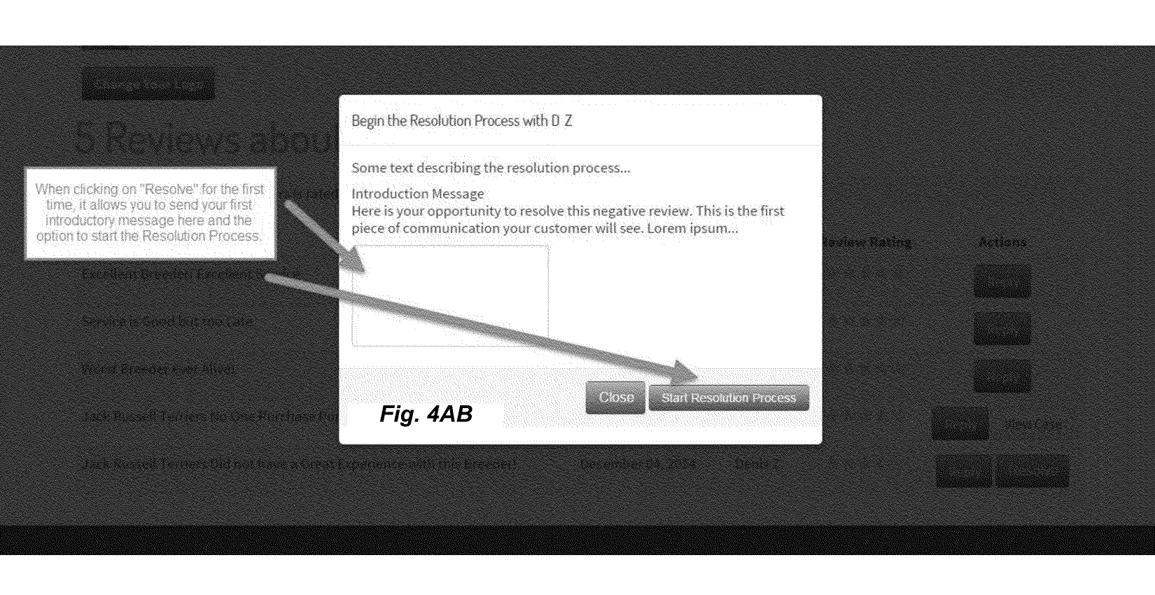

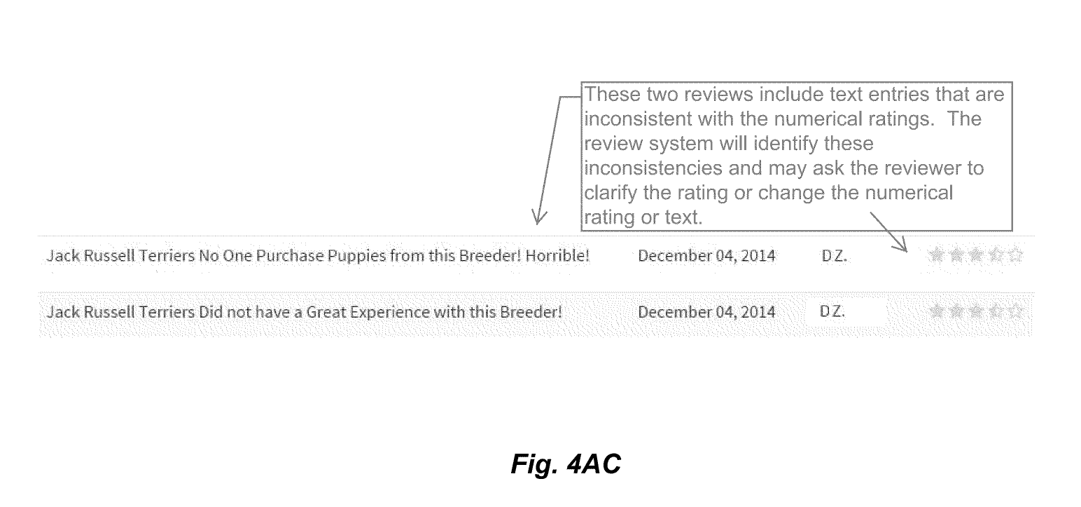

The web server 304 communicates with a rater computer 105, a service provider computer 110, a web application 308, a user database 312, and a rating server 316. The web application 308 generates user interfaces that allow users (the raters and service providers) to interact with the review system 300, create user accounts, enter reviews, respond to reviews, and resolve disputes between raters and service providers. Additionally, the web application 308 may generate alerts notifying a user of a review or a response to a review. The web application 308 may also generate user configurable display images or user interfaces to present information to a user. Examples of user interfaces that may be created by the web application are illustrated in FIGS. 4A-4AC. Although the example user interfaces included in FIG. 4 refer to a review system for an animal breeder service provider of the present invention, it will be appreciated by those of skill in the art that the system of method of the present invention may be used for any type of service provider in any service industry. For example, the review system and method of the present invention may be used with automobile dealers, automobile service providers, cable providers, internet providers, data providers, wireless service providers, restaurants, fast food providers, medical service providers, hospitals, accountants, doctors, veterinarians, kennels, pet sitters, animal trainers (including, but not limited to, dog trainers and cat trainers), lawyers, financial service providers, real estate agents, banks, mortgage brokers, property managers, insurance providers, recreational service providers, parks, hotels, rental properties, retail stores, department stores, grocery stores, plumbers, electricians, programmers, kennels, animal trainers, dog trainers, tour providers, travel consultants, airlines, bus lines, taxis, theaters, and any other type of service provider or service industry.

A rating server 316 is also provided in the review system 300. The rating server 316 communicates with the web server 304, as well as a rating engine 320, a rating database 324, rating thresholds 328, and rating data 332. The rating database 324 stores the rating data 332, which includes all reviews of raters and service providers.

The rating engine 320 reviews and calculates reviews of raters and service providers. The rating engine 320 can identify negative reviews. In one embodiment of the present invention, the rating engine 320 uses rating thresholds 328 to characterize a review and/or a response to the review. Rating thresholds 328 may include a comparator and a deviation value. Comparators include a specification performance comparator, a statistical average performance comparator, and a rater-to-rater and provider-to-provider comparator. The specification performance comparator comprises comparing a single prior review of a service provider or rater to a most recent review. The statistical average performance comparator comprises comparing an average of all reviews for a service provider or rater to a most recent review. The rater-to-rater and provider-to-provider comparators comprise a comparison of one rater or service provider to other raters or service providers in a similar service sector. Rating thresholds 328 are used to evaluate reviews and responses to reviews, to identify negative reviews, and to determine an overall score when a service provider reviews the rater, discussed in more detail below.

The rating engine 320 is operable to request validation of a review from a rater using a user interface generated by the web application 308. Additionally, the rating engine 320 can review validation information submitted by a rater and determine if the validation is sufficient. The rating engine 320 can then notify the reviewed service provider using a user interface generated by the web application 308. Depending on a subscription level of the service provider, the rating engine 320 may optionally give the service provider and opportunity to provide a response to the review. The rating engine 320 is further operable to enable the rater and the reviewed service provider to communicate with each other to resolve a problem identified in the review.

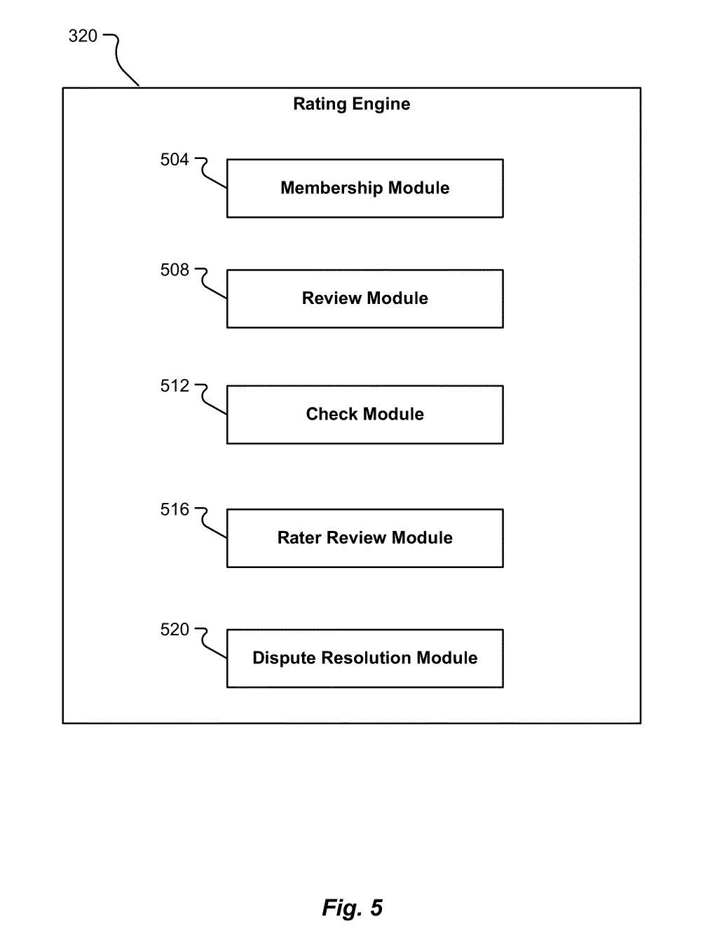

Referring now to FIG. 5, one embodiment of the rating engine 320 of the present invention is illustrated with a membership module 504, a review module 508, a check module 512, a rater review module 516, and a dispute resolution module 520.

The membership module 504 interacts with the web server 304 and web application 308 to generate user interfaces that enable raters and service providers to create a user account with the review system 300. The membership module 504 verifies the user account by requesting an email address and/or a phone number. Before activating a user account, in one embodiment of the present invention, the user must reply to a message sent to the email address or phone number of the user. However, it will be appreciated by one of skill in the art that other methods of verifying a user may be used with the review system of the present invention. The membership module 504 identifies a type of user by requiring the user to select an account type of a service provider or a rater when the user is creating the user account. Optionally, the membership module 504 may require the user to confirm the selection of the account type.

The membership module 504 may request information from a rater such as, but not limited to, first name, last name, phone number, email address, and mailing address (including street address, state, postal code, and country). Different information may be collected for a service provider, such as service provider name, type of service, contact information (for example, business address, phone numbers, email addresses, and a web-page), a description of the service provider, a membership level of the service provider, and a thumbnail or logo of the service provider. The rater and service provider information is stored in the user database 312.

In one embodiment, the membership module 504 may allow the service provider to chose one or more different memberships levels. For example, in one embodiment, the review system may provide three different membership levels for service providers and each membership level may have a different subscription cost, or no subscription cost. In one embodiment of the present invention, the review system 300 includes a first or basic membership level, a second or gold membership level, and a third (or premium or platinum) membership level. A service provider with a basic membership level may receive a notification when a rater submits a review and is allowed to access a service provider forum.

A service provider with a gold membership level receives all the benefits of a basic membership level and additionally can access and benefit from one or more additional features, such as but not limited to: an opportunity to respond to a review, sending review requests to raters to generate reviews for service providers, participation in awards and merits systems, listing the service provider in response to a search by a rater for a service provider, reviewing the rater, and participation in a resolution process. The merit systems may include a top service provider award, a specialist service provider award, a 24 carat gold award, a consumer preferred service provider award for the most valuable service provider based on overall reviews, exceptional wellness award, best in service award, distinguished facility award, and documentation or administrative excellence award. A service provider with a platinum membership level receives all the benefits of a gold membership level and additionally can enable one or more additional features, such as but not limited to: special advertisement features and direct sales leads. For example, a platinum membership level service provider may be listed as a featured service provider when a rater logs into the review system 300 or when a rater searches for a service provider.

The review module 508 is operable to receive a review from a rater for a service provider. In one embodiment, the rater may be a service provider which receives a service from another service provider. Accordingly, in an example of an animal breeder review system 300, the rater may be a breeder that receives an animal from another breeder. Thus, the review system 300 of the present invention facilities peer review of service providers by other service providers.

After the rater has created a user account with the system using the membership module 504, the rater may log-in to the review system 300 and may then initiate a review of a service provider. Each review is assigned a unique identification when created and is stored in the rating database 324. The review module 508 may generate one or more user interfaces using the web application 308. The rater must enter information to identify the reviewed service provider, such as one or more of a name of the service provider, an owner's name, a type of service received, a location of the service provider, a phone number of the service provider, and/or an email address for the service provider. The service provider may or may not have a user account with the review system 300. If the service provider is a registered user with a user account, the review module 508 may ask the rater to verify the identity of the service provider.

The review module 508 then guides the rater through a series of questions to review the performance of the service provider in one or more categories of service. For example, the review module 508 may ask the rater to review the service provider in one or more categories including, but not limited to: performance of service; customer service; facility (such as cleanliness, aesthetics, comfort, location, accessibility, etc.); and document or administrative organization (including, for example, billing accuracy, clarity, etc.). In one embodiment for an animal breeder review system 300, the review module 508 may ask the rater to rate the health of an animal received, customer service provided, facility experience, and document organization.

The review module 508 initially asks the rater to rate the service provider. In one embodiment of the present invention, a scale of from 1 to 5 in each category is used with a rating of 5 being the highest rating. However, any rating scale may be used with the review system 300 of the present invention. Accordingly, in another embodiment, the review module 508 asks the rater to enter a percentage level from 0% to 100% for each category with 100% being the highest rating. Optionally, the rater may enter a null or “not observed” for one or more service categories. In one embodiment, for each category that receives a rating of 4 or less (or 80% or less), the review module 508 may ask the rater to enter comments for how or why the service provided was deficient. Optionally, the review module 508 may provide a user interface where the rater can provide comments about how the service provider could improve the service provided. Thus, the review system 300 of the current invention encourages constructive feedback that can improve the level of service of individual service providers and a service industry. The review module 508 then determines an average rating for the service provider by summing each rating for each service category divided by the total number of service categories.

The review module 508 may require the rater to submit documentation to substantiate the rating and/or that the rater actually conducted business with, or interacted with, the service provider. In one embodiment, the review module 508 may only require substantiating documentation when a rater enters a rating of 3 or less (or 60% or less) in one or more service categories. The documentation may be a receipt or any other document from the service provider that substantiates an interaction by the rater with the service provider. In one embodiment, for an animal breeder review system 300, if the rater indicates that an animal received from a breeder was not healthy, the rater may be required to provide a copy of a health assessment of the animal created by a licensed veterinarian. In another embodiment, the rater may submit a picture to substantiate a negative review, such as a picture showing a safety problem. In one embodiment, when the review is publically posted in the review system 300, the documentation submitted by the rater may also be posted.

The review module 508 may automatically hide a review when documentation is not received within a predetermined amount of time. In one embodiment, the predetermined amount of time may be 72 hours although different time periods may be used, such as 12 hours, 24 hours, 7 days, etc. A hidden review will not be posted and cannot be viewed by other users but will be saved in the rating database 324. The review system 300 considers reviews to be invalid when documentation is not received within the predetermined amount of time. The check module 512 may send periodic reminders to the rater asking for substantiation. In one embodiment, the periodic reminders may be sent every 24 hours until the predetermined amount of time has expired. In one embodiment, a service provider will receive credit for the review, but the review will not be posted. For example, the profile information for the service provider will include the hidden review in the count of all reviews received for the service provider, but the review may include a text statement or icon to indicate that the rater did not document the review and the review has been awarded to the service provider.

The rater may also write a narrative to describe the service received from the service provider. The review module 508 generates a text entry user interface that the rater can use to describe the user's interaction with a service provider.

When a rater completes the review, the check module 512 analyzes the review and may ask for additional information from the rater. The check module 512 is also operable to review the service category reviews and the text of the narrative entry to determine if the narrative correlates with the review of a service category entered by rater. For example, if a rater rates enters reviews with an average of a 4 or 80% but describes the service in negative terms, the check module 512 may determine that the review and the narrative entry are inconsistent and require explanation, editing, and/or documentation from the rater. Alternatively, the rater may provide negative ratings for one or more service categories but describe the service provider positively in the narrative entry. In this example, the check module 508 may also determine that the ratings and the narrative entry are inconsistent and require explanation, editing, and/or documentation from the rater. In one embodiment of the present invention, the check module 512 may flag reviews in which the narrative does not correlate with a numeric value entered by a rater. The flagged reviewed may be sent by the review system 300 to a system operator for validation. An example of reviews identified by the check module 508 as including narrative entries in a user interface that are not consistent with the rating are provided, for example, at FIG. 4AC.

In one embodiment, the check module 512 searches for prohibited words in the narrative entry. The prohibited words may include racial slurs and other inappropriate language. In another embodiment, each review and documentation received from a rater is manually reviewed by a technician of the review system 300. The check module 512 may also determine if a service provider can be contacted using the information entered by the rater. In one embodiment, if the check module 512 cannot contact the service provider, the check module 512 may ask the rater for additional contact and/or location information for the service provider in order to validate the rating of the review. Optionally, in one embodiment, the check module 512 may provide an additional predetermined period of time for the rater to respond to the request for additional information. If the rater does not respond within the predetermined period of time, of if the check module 512 is still unable to locate the service provider using the additional information, the check module 512 may determine that the review is invalid and hide the review.

If the check module 512 determines that the review is valid, the review system 300 may notify both the rater and service provider and provide information about the review. In another embodiment, the review system 300 may post the review and allow access to the review as soon as the review is completed. In still another embodiment, the review system 300 will not post or allow access to the review until after the service provider is given at least an opportunity to respond to the review.

After the rater has entered a review, the review system 300 may contact the service provider reviewed by the rater. If the service provider is not a registered user, the membership module 504 may allow the service provider to register with the review system 300. In one embodiment, the membership module 504 may offer a reviewed service provider that is not a registered user a discounted or trial membership in the review system 300. In this example, if the service provider does not become a registered user, the review system 300 may automatically post the review and allow access to the review. However, in one embodiment, the service provider is notified of the review whether or not the service provider is a registered user.

Depending on the subscription level of the service provider, the review module 508 may provide several options to the service provider. In one embodiment, the service provider may be guided through a series of questions to assess the service provided by the service provider to the rater. For example, the review module 508 may ask the service provider to self-rate the quality of one or more categories of service provided to the rater, including the performance of the primary service, customer service, facilities, and organization of materials provided by the service provider. The service provider may optionally provide a narrative response with each category of service provided. In one embodiment for animal breeder review system 300, the review module may ask the animal breeder to rate: (a) the health of the animal provided to the rater; (b) the customer service provided by the animal breeder to the rater; (c) the facility of the animal breeder where the service was provided to the rater; and (d) the organization of documentation of the animal breeder.

Additionally or alternatively, the service provider may be given an opportunity to respond to additional questions to further assess the service provided. Optionally, the service provider may receive an incentive to respond to the additional questions. Accordingly, in an animal breeder review system 300, the breeder may be asked one or more of the following additional questions: (1) was the animal examined by a veterinarian before purchase by the rater; (2) describe the results of the veterinarian's examination; (3) was the rater informed of medical issues of the animal identified by the veterinarian prior to purchase; (4) provide documentation that the rater was informed of the medical issues; (5) did the rater identify health problems or concerns regarding the animal prior to acceptance of the animal; (6) provide documentation that the rater accepted the animal and waived the rater identified problems; (7) were health problems or concerns of the animal identified by the rater after accepting the animal; (8) when did the rater notify the service provider of the health problems of the animal; (9) did the service provider attempt to resolve the health problem with the rater; (10) did the rater agree to the resolution offered by the service provider; (11) provide documentation that the rater accepted the resolution offered by the service provider; (12) how quickly did the service provider respond to a concern or complaint of the rater; (13) does the service provider follow up with customers determine customer satisfaction or concerns; (14) does the service provider provide a health guarantee for the animal; (15) is the service provider licensed; (16) is the service provider current with any required inspections by the USDA, State regulatory organization, or any other type of government or voluntary association (such as a breeder organization); (17) if inspected, what were the results of the last five inspections; (18) does the service provider give a supply of animal food the animal is currently eating and explain possible problems with changing food; and (19) does the service provider give the rater a copy of a health or veterinarian record for the animal documenting vaccinations, treatments (including worm treatments), and current medications. The membership module 404 may assess the service provider's responses to the additional questions to determine if the service provider qualifies for one or more awards, as described in more detail below. Optionally, basic and gold level members may pay for limited access to all service options.

In one embodiment, after the service provider answers the questions, the check module 512 may review the answers in a manner similar to how the check module 512 reviews a rater's review described above. In other words, the check module may compare a rating with a narrative response entered for each category of service provided to determine if the rating and narrative are consistent. In other embodiment, the check module 512 may review the language of the narrative response to determine if any prohibited words are used. If the check module 512 identifies inconsistencies or prohibited words, the service provider may be notified and given an opportunity to clarify or edit the response.

The rater review module 516 is operable to receive a service provider's review of a rater. In one embodiment, the service provider may review a rater if the service provider has a gold or platinum membership level. Optionally, in another embodiment, a service provider with a basic membership may review a rater for an additional fee.

The rater review module 516 generates one or more user interfaces using the web application 308 for the service provider to review the service provided to the rater. In one embodiment, the rater review module 516 may provide data entry fields for the service provider to review one or more categories of service including, but not limited to: the overall performance of service; customer service; facility; and the service provider's documentation or administrative organization. The service provider may be prompted for a numerical rating (for example on a scale of 1 to 5) or a percentage rating in each category. The rater review module 516 also provides one or more user interfaces that enable to the service provider to enter comments in response to comments entered by the rater. In one embodiment, the service provider may only provide a review for a service category rated 2 or lower (or 59% or lower) by the rater.

The check module 512 reviews the comments and rating received from the rater using the rater review module 516. If a rating is inconsistent with comments received in a narrative by the service provider, the check module 512 may provide an alert to the service provider and ask the service provider to correct or edit the entry. Optionally, the check module 512 may send the review to a technician of the rating system 300 before sending the alert to the service provider.

The check module 512 can also compare entries received from raters using the review module 508 and the entries received from the service entry using the rater review module 516. The check module 512 can then determine an overall score for the service provider. For example, in one embodiment, if a rater provides a rating of “2” for customer service but the service provider enters a rating of “4” for the level of customer service provided to the rater, the check module 512 may assign a overall score of “3” for customer service and list the overall score when the review is posted. In one embodiment, the check module 512 averages the ratings entered by the rater and the service provider to determine the overall score. In another embodiment, more weight is provided to raters' rating. In yet another embodiment, the check module 512 uses comparator data retrieved from rating thresholds 328 in the ratings database 324 to determine the overall score. In still another embodiment, if a rater enters multiple ratings for multiple service providers, the ratings entered by the rater may be adjusted by the check module 512 based on a determined reliability of the rater using information from the ratings thresholds 328. Accordingly, ratings of a rater known to provide biased or misleading ratings may receive less weight than a service provider's ratings. However, ratings of a rater that consistently provides reliable ratings may receive more weight than the rating of a service provider. In yet another embodiment, ratings of a service provider that is identified as a reliable service provider or an unreliable service provider may accordingly receive more or less weight than the ratings of a rater. The reliability of the service provider may be determined, in one embodiment, by previously received ratings of the service provider retrieved from the rating database 324 and information from the rating thresholds 328.

The dispute resolution module 520 allows a rater and a reviewed service provider to communicate and at least attempt to resolve a problem. The rater is given an option to activate the dispute resolution module 520 after entering a review. In one embodiment, service providers of all membership levels may activate the dispute resolution module 520 after a review is entered by a rater. In another embodiment, only service providers with platinum membership level may activate the dispute resolution module 520. In still another embodiment, basic and gold membership level service providers may activate the dispute resolution module 520 by paying an additional fee. In yet another embodiment, the rater is only given the option to activate the dispute resolution module 520 if the rated service provider has a platinum membership. In one embodiment, after a rater enters a review, both the rater and the service provider are contacted by the rating system 300 and given an opportunity to begin the dispute resolution process. In one embodiment, the contact is by an electronic message. If neither the rater nor the service provider begin the dispute resolution process, the dispute resolution module 520 may periodically contact both the rater and the service provider and provide another opportunity to begin the dispute resolution process.

When either the rater or the service provider initiates the dispute resolution process, the dispute resolution module 520 generates one or more user interfaces using the web application 308. The dispute resolution module 520 notifies one of the rater and the service provider that the other of the rater and the service provider has initiated the dispute resolution process. The one of the rater and the service provider may then decline to participate in the dispute resolution process in which case the other of the rater and the service provider is notified and the review is posted. If the one of the rater and the service provider accepts participation in the dispute resolution process, the dispute resolution module 520 provides a direct communication between the rater and the service provider. The direct communication may be, by way of example, a private chat room, an email communication, or a teleconference number. It will be appreciated that other communication methods may be used with the rating system of the present invention to enable the rater and service provider to communicate. The dispute resolution module 520 can provide multiple sessions of direct communication between the rater and the service provider. In one embodiment, the direct communication between the rater and the service provider is saved in the rating database 324.

At any time during the dispute resolution process, either the rater or the service provider may end the process. One or more of the rater and the service provider may select a user interface to terminate the dispute resolution process without resolving the dispute. The review will then be posted. Alternatively, the rater and the service may both select a user interface indicating the dispute is resolved. The dispute resolution module 520 will then send a notification to the rater asking the rater to revise the review. The review module 508 may then present the original review to the rater and allow the rater to edit the review. The check module 512 then analyzes the revised review. After the rater has revised the review, the review system 300 notifies the service provider that the rater has revised review. In one embodiment, both the rater and the service provider are notified that if the actions agreed to during the dispute resolution process are not performed, the rater can contact the review system 300 and given another opportunity to revise the review. In another embodiment, if the rater submits a complaint that the service provider has not performed duties agreed to during the dispute resolution process, the review system 300 will take down the revised review. Additionally or alternatively, the review system 300 may post the rater's original review or a new review submitted by the rater. Accordingly, the rater may be given an opportunity to update the original review such as to include information that the service provider agreed to resolve a complaint but did not perform duties agreed to in the dispute resolution process.

When the review is completed, the membership module 504 may use the review information stored in the rating database 324 to determine if the service provider qualifies for one or more awards. If the service provider answered the additional questions generated by the review module 508, the membership module 504 may assign a score to the service provider based upon the responses received. In one embodiment, for each question answered correctly, the service provider will receive a predetermined number of points. The total points are then determined and divided by one or more predetermined factors to determine a cumulative response. If the service provider's cumulative response is greater than a predetermined amount, the service provider will be rated as a professional service provider and if the service provider is registered with the review system 300, the service provider's profile will be labeled accordingly. In one embodiment, the service provider will be rated as a professional service provider if the cumulative response is greater than 3 on a scale of 0-6. In another embodiment, cumulative response is determined by asking the service provider 12 questions for a first score of 12 possible points. The service provider is then asked 7 additional questions for a second score of 3.5 possible points. The first score is divided by 2 and added to the second score divided by 3.5 to determine the cumulative response score.

The membership module 504 may determine the service provider qualifies for one or more additional awards once the service provider has received 50 reviews. In one embodiment, the additional awards are determined after a predetermined period of time such as, but not limited to, annually. In another embodiment, the 50 reviews must be received within 1 year. The service provider may receive a customer preferred service provider award if the overall rating for the service provider is above a predetermined number. The membership module 504 may also determine a service provider qualifies for an exceptional service award if the overall rating in the performance of the primary service category for the service provider is above the predetermined number. An exceptional customer service award may be assigned to the service provider by the membership module 504 if the overall rating in the customer service category is above the predetermined number. The service provider may also receive a distinguished facility award if the overall rating in the facility category is above the predetermined number. An exceptional organization excellence award may be granted if the overall rating in the organization category for the service provider is above the predetermined number. In one embodiment, the predetermined number is greater than 4 on a scale of 1 to 5 or greater than 80%. In another embodiment, each award is based on geography and further by a particular type or subset of service provided. For example, in an animal breeder review system 300, each award may be further divided by a breed of animal provided.

The membership module 504 may also determine a service provider qualifies for a service provider specialist award when the service provider receives a predetermined number of reviews from other service providers in the same service sector. For example, if an animal breeder is reviewed by a predetermined number of animal breeders, the membership module 504 may determine the service provider qualifies for the service provider specialist award. In one embodiment, the service provider must receive an overall rating above a predetermined amount from the other service providers.

A service provider may also be rated as a top service provider. The membership module 504 may award up to 10 top service provider awards in one or more geographic areas. The membership module 504 determines a service provider qualifies as a top service provider if the service provider receives greater than a predetermined number of reviews from other service providers in the same service sector and the service provider's overall rating is one of the 10 highest of all service providers in the geographic area. In one embodiment, the geographic area is a state within the United States. In another embodiment, the geographic area is an area with a 300 mile radius. In still another embodiment, the predetermined number of reviews from other service providers is at least three reviews.

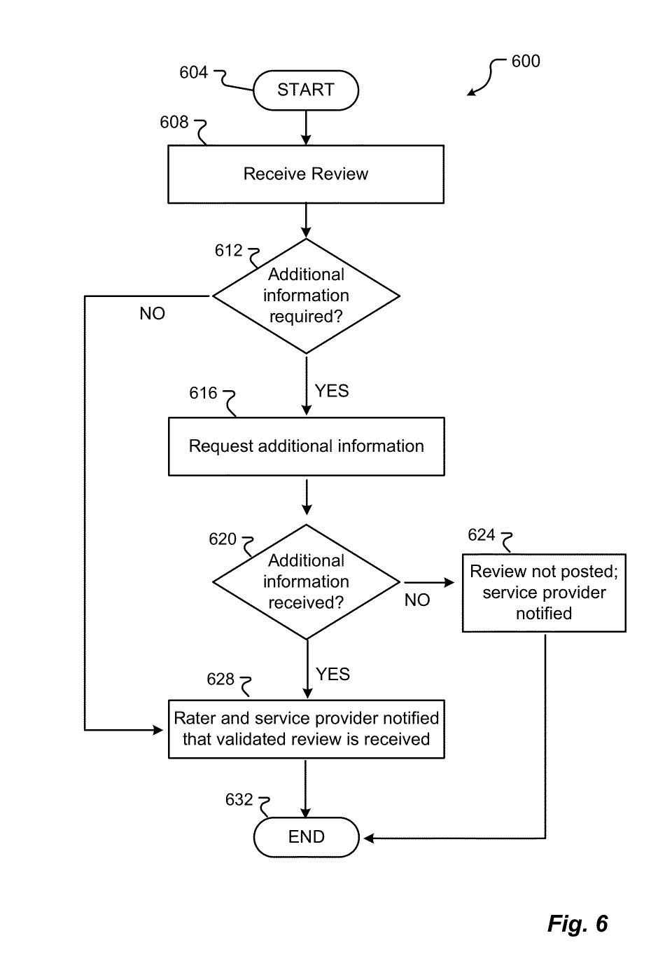

An embodiment of a method 600 for receiving a review of a service provider from a rater may be as shown in FIG. 6. A general order for the operations of the method 600 is shown in FIG. 6. Generally, the method 600 starts with a start operation 604 and ends with an end operation 632. The method 600 can include more or fewer operations or can arrange the order of the operations differently than those shown in FIG. 6. The method 600 can be executed as a set of computer-executable instructions executed by a computer system and encoded or stored on a computer readable medium. Hereinafter, the method 600 shall be explained with reference to the systems, components, modules, software, data structures, user interfaces, etc. described in conjunction with FIGS. 1-5.

The review module 508 of the review system 300 can receive a review of a service provider from a rater in operation 608. The check module 512 may then compare the received review to determine if the review rates the service provider below a predetermined value in operation 612. If the review is above the predetermined value, no additional information is required from the rater and method 600 precedes NO to 628. If the review is below the predetermined value, method 600 proceeds YES to 616 and additional information is requested from the rater. Additionally or alternatively, if the rated service provider cannot be identified the method may proceed YES to 616. The method 600 then waits a predetermined amount of time. If the rater does not provide the additional information, method 600 precedes NO to operation 624 and the review is not posted and the service provider is notified of the unvalidated review. Method 600 then proceeds to End 632. If in operation 620, the rater does provide the additional information, method 600 proceeds YES to operation 628 and the rater and service provider are notified of the validated review. Method 600 may then proceed to End 632.

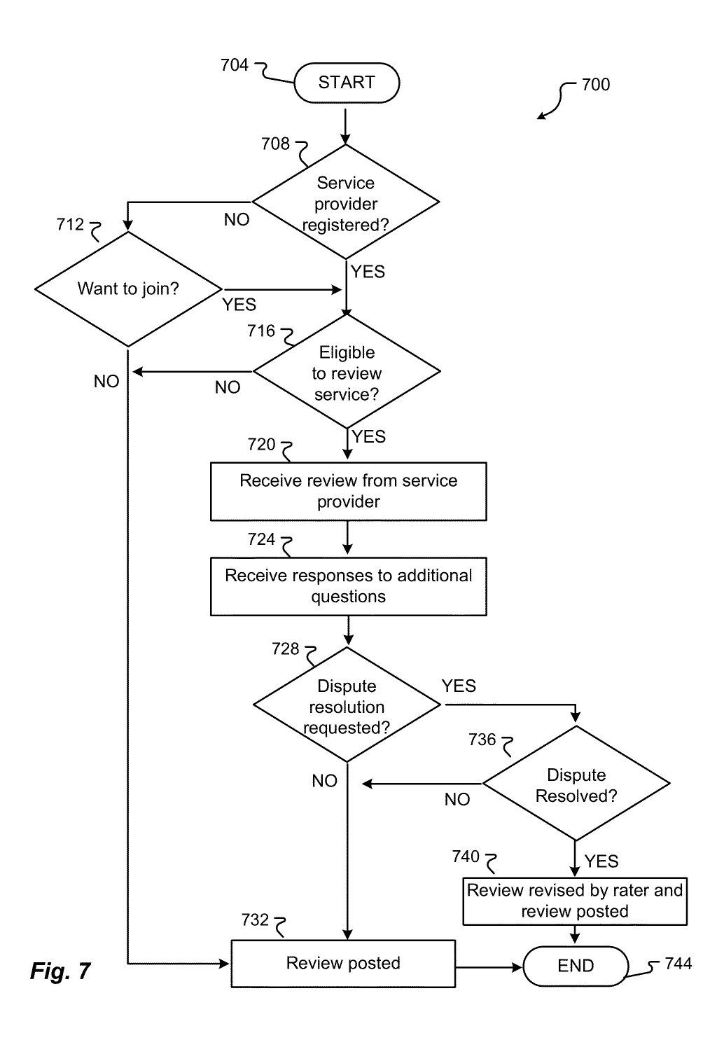

An embodiment of a method 700 for a service provider to rate the level of service provided to a rater may be as shown in FIG. 7. A general order for the operations of the method 700 is shown in FIG. 7. Generally, the method 700 starts with a start operation 704 and ends with an end operation 744. The method 700 can include more or fewer operations or can arrange the order of the operations differently than those shown in FIG. 7. The method 700 can be executed as a set of computer-executable instructions executed by a computer system and encoded or stored on a computer readable medium. Hereinafter, the method 700 shall be explained with reference to the systems, components, modules, software, data structures, user interfaces, etc. described in conjunction with FIGS. 1-6.

Method 700 may begin after end 632 of method 600. In operation 708, the membership module 504 determines if the service provider is registered with the review system 300. If the service provider is registered, method 700 proceeds YES to 716. If the service provider is not registered, method 700 precedes NO to 712. At operation 712 the membership module 504 offers the service provider an opportunity to register with the review system 300. If the service provider wants to join the review system 300, membership module 504 creates a user account for the service provider and method 700 proceeds YES to operation 716. If the service provider does not want to join the review system 300, method 700 proceeds NO to 732 and the review is posted.

At operation 716, the membership module 504 determines the subscription level of the service provider to determine if the service provider is eligible to provide comments and review the review. If the service provider is not eligible to review the review, the method precedes NO to 732 and the review is posted. Optionally, in one embodiment, if the service provider is not eligible to review the review, the method loops NO to operations 712 where the membership module 504 offers the service provider an opportunity to upgrade the membership level to be eligible to review the review. If the service provider is eligible, method 700 proceeds YES to operation 720 where the review module 508 can receive the service provider's review of the level of service provided to the rater. The review module 508 may then receive the service provider's responses to one or more optional additional questions in operation 724.

In operation 728 the review system 300 can determined if either the rater or the service provider have requested dispute resolution. If dispute resolution system is not requested, method 700 precedes NO to operation 732 and the review is posted. If the dispute resolution system is requested, method 700 proceeds YES to operation 736 and the dispute resolution module 720 links the rater and the service provider so they may attempt to resolve the problem identified by the rater. If rater and service provider do not resolve the dispute, or if one of the service provider and the rater refuse to participate in the dispute resolution process, method 700 proceeds NO to operation 732 and the review is posted. If the rater and service provider do resolve the dispute, method 600 proceeds YES to operation 740. The rater is then given the opportunity to revise the review. The revised review is then posted in operation 740. Method 700 then proceeds to end 744.

The exemplary systems and methods of this disclosure have been described in relation to systems and methods of reviewing service providers and raters. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, options, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a Personal Computer (PC), laptop, netbook, smart phone, Personal Digital Assistant (PDA), tablet, etc., or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

It should be appreciated that the various processing modules (e.g., processors, modules, etc.), for example, can perform, monitor, and/or control critical and non-critical tasks, functions, and operations, such as interaction with raters and service providers.

Optionally, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system, comprising:
a communication interface configured to receive a communication comprising a review of a service provider from a rater; and
a processor configured to:
receive the review from the communication interface;
identify the rater;
determine if additional information is required from the rater;
evaluate the review received from the rater;
identify the service provider associated with the review;
notify the service provider and the rater when the review system validates the rater's review;
determine if the service provider is registered with the system;
determine if the service provider is eligible to provide a review of the rater's review;
receive the service provider's review;
receive responses to additional questions from the service provider;
determine if a dispute resolution process is requested by one of the rater and the service provider; and
post the review.

2. The system of claim 1, further comprising:
a web server;
a user database;
a rating database that stores review of raters and service providers; and
a rating engine to identify negative review and request validation of the review from the rater.

3. A method of providing a review system, comprising:
receiving an identified rater's review of a service provider;
determining if additional information is required from the rater;
evaluating the rater's review;
notifying the service provider and the rater when the review system validates the rater's review;
determining if the service provider is registered with the review system;
determining if the service provider is eligible to provide a review of the rater's review;
receiving the service provider's review;
receiving responses to additional questions from the service provider;
determining if a dispute resolution process is requested by one of the rater and the service provider; and
posting the review.
